(19) United States
(12) Patent Application Publication
(10) Pub. No.: US 2026/0093092 A1
(43) Pub. Date: Apr. 2, 2026

(54) OPTICAL SYSTEM AND CAMERA MODULE

(71) Applicant: LG INNOTEK CO., LTD., Seoul (KR)

(72) Inventor: Seok Jae WON, Seoul (KR)

(21) Appl. No.: 19/113,793

(22) PCT Filed: Sep. 19, 2023
(86) PCT No.: PCT/KR2023/014150

§ 371 Date: Mar. 20, 2025

(30) Foreign Application Priority Data
Sep. 20, 2022 (KR) 10-2022-0118844

(51) Int. Cl. G02B 13/00

(52) U.S. Cl. CPC G02B 13/003

(57) ABSTRACT

The optical system disclosed in the embodiment first to fifth lenses sequentially disposed from an object side, wherein a composite power of the first lens and the second lens are negative, a composite power of the third to fifth lenses are positive, an effective diameter of the second lens among the first to fifth lenses is the smallest, an effective diameter of the first lens is larger than the effective diameter of the second lens and smaller than the effective diameters of the third to fifth lenses, and a power of the third lens among the first to fifth lenses is the largest, and a power of the fourth lens among the first to fifth lenses is the second largest.

### TECHNICAL FIELD

An embodiment relates to an optical system and a camera module including the same.

### BACKGROUND ART

ADAS (Advanced driving assistance system) is an advanced driver assistance system to assist the driver in driving, and it consists of sensing the situation ahead, judging the situation based on the sensed results, and controlling the behavior of the vehicle based on the situation judgment. Due to the rapid global growth of ADAS, the driver monitoring system (DMS) is quickly becoming an important safety feature.

The camera for DMS linked to the advanced driver assistance system is placed inside the vehicle and can detect the situation of the driver and passengers. For example, the camera can photograph the driver at a location adjacent to the driver and can detect the driver's health status, whether he or she is drowsy, whether he or she is drinking, etc. In addition, the camera can photograph the passenger at a location adjacent to the passenger and can detect whether the passenger is sleeping, whether he or she is healthy, etc., and can provide information about the passenger to the driver.

The most important element for obtaining an image from a camera is the imaging lens that forms the image. Recently, interest in high-definition and high-resolution, etc., has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics. Therefore, new optical systems and cameras that can solve the above-described problems are required.

### DISCLOSURE

### Technical Problem

An embodiment may provide an optical system and a camera module having improved optical characteristics. An embodiment provides an optical system and a camera module having excellent optical performance in low-temperature to high-temperature environments. An embodiment provides an optical system and a camera module capable of preventing or minimizing changes in optical characteristics in various temperature ranges. The embodiment may be provided for a camera for an interior of a vehicle or a DMS.

### Technical Solution

An optical system according to an embodiment of the invention comprises first to fifth lenses sequentially disposed from an object side, wherein a composite power of the first lens and the second lens are negative, a composite power of the third to fifth lenses are positive, an effective diameter of the second lens among the first to fifth lenses is the smallest, an effective diameter of the first lens is larger than the effective diameter of the second lens and smaller than the effective diameters of the third to fifth lenses, a power of the third lens among the first to fifth lenses is the largest, and a power of the fourth lens among the first to fifth lenses is the second largest.

An optical system according to an embodiment of the invention includes first to fifth lenses sequentially disposed from an object side, wherein a composite power of the first lens and the second lens are negative, a composite power of the third to fifth lenses are positive, an effective diameter of the second lens among the first to fifth lenses is the smallest, a power of the third lens among the first to fifth lenses is the largest, and an optical axis distance from an object-side surface of the first lens to a sensor-side surface of the second lens may be in a range of 26% to 36% of an optical axis distance from an object-side surface of the third lens to a sensor-side surface of the fifth lens.

An optical system according to an embodiment of the invention includes first to fifth lenses sequentially disposed from an object side; and an aperture stop disposed on the periphery between the first lens and the second lens, wherein the effective diameter of the second lens among the first to fifth lenses is the smallest, a power of the third lens is positive and has the largest among the power of the first to fifth lenses, and the power of the fourth lens is positive and may be greater than the powers of the first, second, and fifth lenses.

According to an embodiment of the invention, an image sensor is included, and a curvature radius of an object-side surface and a sensor-side surface of the fourth lens are the same, and a center thickness of the fourth lens among the first to fifth lenses may be the thickest.

According to an embodiment of the invention, a center distance between the third lens and the fourth lens may be greater than a center distance between the first lens and the second lens and a center distance between the second lens and the third lens. According to an embodiment of the invention, a center distance between the fourth lens and the fifth lens may be the largest among the center distances between the first to fifth lenses. According to an embodiment of the invention, the first to fifth lenses may be disposed to be spaced apart from each other along the optical axis. According to an embodiment of the invention, a power of each of the two lenses arranged in series with positive power on a sensor side of the aperture stop may be at least twice as large as the absolute value of the power of the other lens.

According to an embodiment of the invention, an image sensor may be included, and an optical axis distance from the object-side surface of the third lens to the image sensor disposed on the sensor side of the fifth lens may be in a range of 75% to 85% of an optical axis distance from an object-side surface of the first lens to the image sensor. According to an embodiment of the invention, the first lens may have a meniscus shape convex from the optical axis toward the object side, and the second lens may have a meniscus shape convex from the optical axis toward the sensor side.

According to an embodiment of the invention, the third lens may have a biconvex shape from the optical axis, and the fourth lens may have a biconvex shape from the optical axis. The fifth lens may have a convex meniscus shape from the optical axis toward the sensor side. The first lens may have an aspherical object-side surface and a sensor-side surface.

According to an embodiment of the invention, the second to fifth lenses may have a spherical object-side surface and a sensor-side surface. The effective diameter of the third to fifth lenses may be smaller than the diagonal length of the image sensor. The refractive indices of the third and fourth lenses may be higher than the average of the refractive indices of the first to fifth lenses. The first to fifth lenses may be made of glass, and the object-side surface and the sensor-side surface may be provided without a critical point.

According to an embodiment of the invention, S7SagD1 is Sag data at a point spaced apart from the center of the object side of the fourth lens by a first distance, and S8SagD1 is Sag data at a point spaced apart from the center of the sensor side of the fourth lens by a first distance, and the following Equation may satisfy: |S7SagD1|−|S8SagD1|<0.2 mm. The first distance is a point which is half of the average effective radius of the object-side surface and the sensor-side surface of the fourth lens, and the following Equation may satisfy: S7SagD1>0 and S8SagD1<0. The maximum distance in the optical axis direction from a straight line perpendicular to the optical axis on the object-side surface of the fifth lens to the object-side surface of the fifth lens is Max_Sag51, and the maximum distance in the optical axis direction from a straight line perpendicular to the optical axis on the sensor-side surface of the fifth lens to the sensor-side surface of the fifth lens is Max_Sag52, and the following Equation may satisfy: |Max_Sag52|<Max_Sag51|. The following Equation may satisfy: Max_Sag51<0 and Max_Sag51<0.

A camera module according to an embodiment of the invention includes the optical system disclosed above, wherein an optical axis distance from an object-side surface of the first lens to an image sensor is TTL, a total number of lenses is nL, a number of aspherical lenses among the first to fifth lenses is nASL, and half of a diagonal length of the image sensor is ImgH, and the following Equations may satisfy: 3<TTL/ImgH<5 and 0<nASL/nL<0.5.

### Effects of the Invention

An optical system and a camera module according to an embodiment may have improved optical characteristics. In detail, in the optical system according to an embodiment, a plurality of lenses may have set thicknesses, powers, and intervals with adjacent lenses. Accordingly, the optical system and camera module according to the embodiment may have improved MTF characteristics, aberration control characteristics, resolution characteristics, etc. in the set field of view range, and may have good optical performance in the periphery of the field of view.

The optical system and camera module according to the embodiment may have good optical performance in the temperature range of low temperature (about −20° C. to −40° C.) to high temperature (85° C. to 105° C.). In detail, the plurality of lenses included in the optical system may have set materials, power, and refractive index. Accordingly, even when the focal length of each lens changes due to a change in refractive index according to a change in temperature, the lenses can mutually compensate. That is, the optical system can effectively perform power distribution in the low temperature to high temperature range, and can prevent or minimize changes in optical characteristics in the low temperature to high temperature range. Therefore, the optical system and camera module according to the embodiment can maintain improved optical characteristics in various temperature ranges.

The optical system and camera module according to the embodiment may satisfy the set field of view and implement excellent optical characteristics by mixing an aspherical lens and a spherical lens. This allows the optical system to provide a slimmer vehicle camera module. Accordingly, the optical system and camera module may be provided for various applications and devices, and may have excellent optical properties even in harsh temperature environments, such as when exposed to the outside of a vehicle or inside a vehicle at high temperatures in summer. The embodiment can improve the reliability of a camera for vehicle interiors or DMS.

### DESCRIPTION OF DRAWINGS

FIG. 1 is a side cross-sectional view of an optical system according to an embodiment and a camera module having the same.

FIG. 2 is a side cross-sectional view for explaining the relationship between the n-th and n−1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing center thicknesses of each lens and center distances between adjacent lenses in the optical system of FIG. 1.

FIG. 6 is a table showing sag data on the object-side surface and sensor-side surface of the n-th and n−1th lenses in the optical system of FIG. 1 from the optical axis to the end of the effective region.

FIG. 7 is a graph showing data on diffraction MTF (Modulation Transfer Function) at room temperature of the optical system of FIG. 1.

FIG. 8 is a graph showing data on diffraction MTF at low temperature of the optical system of FIG. 1.

FIG. 9 is a graph showing data on the diffraction MTF of the optical system of FIG. 1 at high temperatures.

FIG. 10 is a graph showing data on the aberration characteristics of the optical system of FIG. 1 at room temperature.

FIG. 11 is a graph showing data on the aberration characteristics of the optical system of FIG. 1 at low temperatures.

FIG. 12 is a graph showing data on the aberration characteristics of the optical system of FIG. 1 at high temperatures.

FIG. 13 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region where the distance a light ray falls from the optical axis OA is almost 0. Hereinafter, the optical axis may include the center of each lens or a very narrow region near the optical axis.

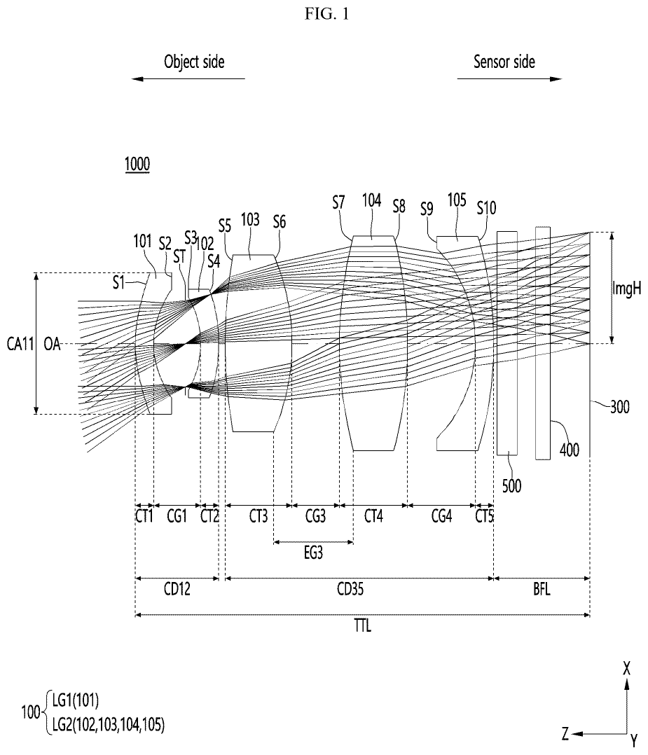

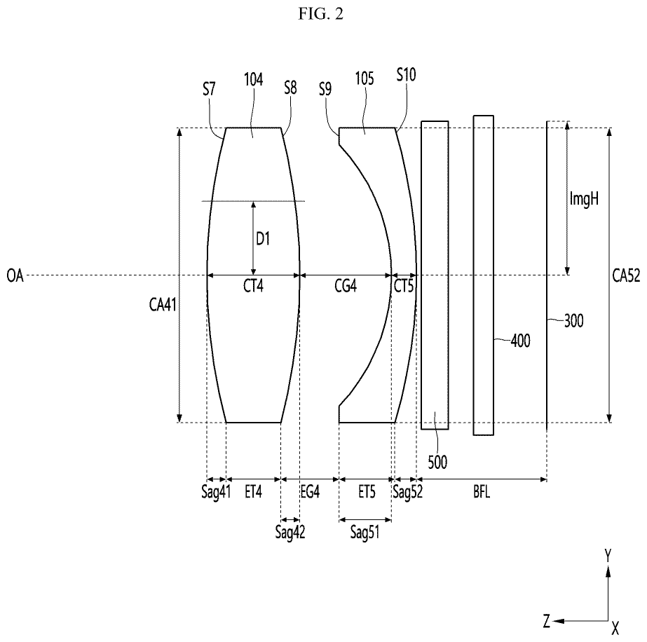

As shown in FIGS. 1 and 2, the optical system 1000 according to the embodiment of the invention may include a plurality of lens groups LG1 and LG2. In detail, each of the plurality of lens groups LG1 and LG2 includes at least one lens. For example, the optical system 1000 may include a first lens group LG1 and a second lens group LG2 which are sequentially disposed along the optical axis OA from the object side toward the image sensor 300. The number of lenses of each of the first lens group LG1 and the second lens group LG2 may be different from each other. The number of lenses of the second lens group LG2 may be greater than the number of lenses of the first lens group LG1, for example, may be more than two times or more than three times the number of lenses of the first lens group LG1. The optical system 1000 may include n lenses, and an n-th lens may be the lens closest to the image sensor 300, and an n−1th lens may be the lens closest to the n-th lens. The n is an integer less than or equal to 6, for example, 4 to 6. The first lens group LG1 may include at least one lens. The first lens group LG1 may have two or less lenses, for example, one lens. The second lens group LG2 may include three or more lenses or four or more lenses. The second lens group LG2 may include four lenses.

The first lens group LG1 may include at least one lens made of glass. The first lens group LG1 may provide the lens closest to the object side as a lens made of glass. This glass material has a small amount of expansion and contraction change due to external temperature changes, and the surface is not easily scratched, so surface damage may be prevented. The lens material of the second lens group LG2 may include at least one glass material lens and at least one plastic material lens. Preferably, the lenses of the second lens group LG2 may include glass lenses. The first lens group LG1 may include at least one aspherical lens. The second lens group LG2 may include at least one spherical lens and at least one aspherical lens. The lenses of the second lens group LG2 may include spherical lenses. Here, a spherical lens is a lens in which an object-side surface and a sensor-side surface of a lens are spherical in the optical axis, and an aspherical lens is a lens in which an object-side surface or/and a sensor-side surface of a lens are aspherical. Here, since the first lens is provided as an aspherical lens closest to the object, the thickness of the first lens may be provided thinner than a spherical lens, color dispersion may be lowered for a short TTL, and image distortion in the periphery may be reduced. The first lens may be a glass mold lens. The lens made of the glass mold material is a lens that is injection-molded to have an aspherical surface using glass material. The TTL (Total track length) is an optical axis distance from the center of the object-side surface of the first lens to the surface of the image sensor 300.

The optical system 1000 is disposed with glass lenses, so that heat compensation is possible within the lens barrel, and deterioration of optical characteristics due to temperature change may be suppressed. In addition, since the optical system 1000 includes at least one aspherical lens, various aberrations may be suppressed.

The maximum Abbe number of the lenses of the optical system 1000 is 55 or more, and the lens having the maximum refractive index is located in the second lens group LG2 and may be 1.70 or more. The lens having the maximum Abbe number may reduce chromatic dispersion, and the lens having the maximum refractive index may increase chromatic dispersion of incident light. The refractive index of the i-th lens is Ndi, the Abbe number of the i-th lens is Adi, and the value of Ndi*Adi may be maximum when i is at least one or all of 1, 2, and 5. In addition, the value of Ndi*Adi may not be less than 55 when i=1, 2, 3, 4, and 5, and the value of Ndi*Adi may not be less than 50. The lens having the minimum effective diameter in the optical system 1000 may satisfy the condition that the value of Ndi*Adi is 80< (Ndi*Adi)<120, and * indicates multiplication in the specification.

Within the lens unit 100, a lens having a maximum effective diameter may be a spherical lens, and a lens having a minimum effective diameter may be a spherical lens. The effective diameter of each lens may be the diameter of an effective region where effective light is incident on each lens, and is an average of the effective diameter of the object-side surface and the effective diameter of the sensor-side surface. Here, within the lens unit 100, the lens having the maximum Sag value in absolute value is the lens having the minimum effective diameter, and the lens having the second largest Sag value is the n-th lens. Here, the Sag value is the distance in the direction of the optical axis between a straight line perpendicular to the center of the object-side surface or the center of the sensor-side surface of each lens and the object-side surface or the sensor-side surface. An embodiment of the invention may arrange an aspherical lens on the object side within the optical system 1000, and increase the Sag values of the lens having the minimum effective diameter and the n-th lens, thereby allowing light to spread. Accordingly, since the object-side surface and the sensor-side surface of the n-th lens are provided without a critical point, the total length TTL may be reduced.

Each of the lenses may include an effective region and an ineffective region. The effective region may be a region through which light incident on each of the lenses passes. That is, the effective region may be defined as an effective region or effective diameter in which the incident light is refracted to implement optical characteristics. The ineffective region may be disposed around the effective region and may be defined as a flange portion. The ineffective region may be a region in which effective light is not incident on the plurality of lenses. That is, the ineffective region may be an area unrelated to the optical characteristics. In addition, the end of the ineffective region may be an area fixed to a lens barrel (not shown) that accommodates the lens.

In the optical system 1000, the TTL (Total top length) may be more than 3 times, for example, more than 3 times and less than 5 times, than ImgH. Preferably, the following condition may satisfy: 3<TTL/ImgH<5. The ImgH is half of the diagonal length of the image sensor 300 in the optical axis OA. In the optical system 1000, the effective focal length (EFL) is 10 mm or less and the diagonal field of view (FOV) is more than 45 degrees, so that the optical system may be provided as a standard optical system in a vehicle camera module. That is, the focal length may be reduced to 10 mm or less for the diagonal field of view. For example, the optical system and the camera module according to the embodiment may be applied to a camera module for DMS provided in a vehicle interior. The optical system 1000 may have a value of TTL/(2*ImgH) greater than 1.5, and may satisfy, for example, the following condition: 1.5<TTL/(2*ImgH)<2.5. The optical system 1000 can provide an optical system for driver monitoring by setting the value of TTL/(2*ImgH) to less than 2.5. The total number of lenses of the first and second lens groups LG1 and LG2 is 6 or less. Accordingly, the optical system 1000 may provide an image without exaggeration or distortion of the image being formed.

A length of the image sensor 300 is the maximum length of the diagonal in the direction orthogonal to the optical axis OA. The number of lenses having an effective diameter greater than the diagonal length of the image sensor 300 in the optical system 1000 is 1 or less, and the number of lenses having an effective diameter smaller than the length of the image sensor 300 may be 4 or more. Preferably, the lens having an effective diameter greater than the diagonal length of the image sensor 300 may be the n-th lens or the n−1th lens, or none. The diagonal length of the image sensor 300 may be greater than the diameters of the spherical lenses. The diagonal length of the image sensor 300 may be greater than the diameter of the aspherical lens. Preferably, ½ of the diagonal length of the image sensor 300 may be greater than the minimum effective diameter of the lens.

The aperture stop ST may control the amount of light incident on the optical system 1000. The aperture stop ST may be disposed between any two lenses in the lens unit 100. The lenses adjacent to the object side and the sensor side of the aperture stop ST have an effective diameter smaller than the effective diameter of the n-th lens, and the effective diameter of the lens adjacent to the object side of the aperture stop ST may be larger than the effective diameter of the lens adjacent to the sensor side of the aperture stop. The effective diameter of the lens adjacent to the sensor side of the aperture stop ST may be the minimum effective diameter. In this way, by reducing the effective diameters of the two lenses adjacent to the aperture stop ST, a slim optical system may be provided. The center thicknesses of the two lenses adjacent to the object side and the sensor side of the aperture stop ST may be thinner than the center thicknesses of the n−1th lens and the n−2th lens, so that the TTL may be reduced. In addition, the center thickness of the first lens of the optical system may be provided to be thinner than the center thickness of the last lens, and the refractive angle may be increased by the maximum Sag value. By controlling the effective diameter and Sag value of each of the above lenses, it is possible to control the light incident on an image sensor 300 having at least 2 megabytes of pixels, compensate for the deterioration of optical characteristics due to resolution and temperature changes within the optical system, improve the chromatic aberration control characteristics, and improve the vignetting characteristics of the optical system 1000.

In the lens surfaces arranged between the object and the aperture stop ST, the effective diameter of the lens surfaces tends to decrease as it goes from the object side to the aperture stop ST. In the lens surfaces disposed between the aperture stop ST and the image sensor 300, the effective diameter of the lens surfaces tends to increase as it goes from the aperture stop ST to the sensor side. ‘The effective diameter of the lenses tends to increase as they go from the aperture stop ST to the sensor side’ means that the lens surfaces arranged between the aperture stop ST and the image sensor 300 may include lens surfaces whose effective diameters gradually increase or decrease as they go from the aperture stop ST to the sensor side.

The aperture stop ST may be disposed around the object-side surface of the lens closest to the object side among the lenses of the second lens group LG2. Alternatively, the aperture stop ST may be disposed around the sensor-side surface of the lens closest to the object. Alternatively, at least one lens selected from the plurality of lenses may serve as an aperture stop. In detail, the object-side surface or the sensor-side surface of one lens selected from the lenses of the optical system 1000 may serve as an aperture stop for controlling the amount of light.

The optical axis distance between the first lens group LG1 and the second lens group LG2 may be the optical axis distance between the sensor-side surface of the first lens group LG1 and the object-side surface of the second lens group LG2. The optical axis distance between the first lens group LG1 and the second lens group LG2 may be the center distance between the aspherical lens and the spherical lens, and may be greater than the center distance between the spherical lenses. The optical axis distance between the first lens group LG1 and the second lens group LG2 may be more than 1 time the optical axis distance of the first lens group LG1, for example, may be in a range of 2 to 3 times the optical axis distance of the first lens group LG1. The optical axis distance between the first lens group LG1 and the second lens group LG2 may be less than 0.3 times the optical axis distance of the second lens group LG2, for example, may be more than 0 times and less than 0.3 times. The optical axis distance of the first lens group LG1 is the optical axis distance from the object-side surface to the sensor-side surface of the first lens. The optical axis distance of the second lens group LG2 is the optical axis distance between the object-side surface of the lens closest to the object side of the second lens group LG2 and the sensor-side surface of the lens closest to the image sensor 300. Here, the first lens group LG1 may include lenses positioned closer to the object side than the aperture stop ST, and the second lens group LG2 may include lenses positioned closer to the sensor side than the aperture stop ST. The first lens group LG1 and the second lens group LG2 may be divided into an object-side lens group and a sensor-side lens group based on the aperture stop ST. The sensor-side surface of the first lens group LG1 may have a concave shape on the optical axis, and the object-side surface of the second lens group LG2 may have a convex shape on the optical axis, and they can face each other.

The first lens group LG1 may have negative (+) power, and the second lens group LG2 may have positive (+) power. The lens closest to the object side in the first lens group LG1 may have positive (+) power, and the lens closest to the sensor side among the lenses of the second lens group LG2 may have negative (−) power. When the absolute value of the focal length of the first lens group LG1 is F_LG1 and the absolute value of the focal length of the second lens group LG2 is F_LG2, the following condition may satisfy: F_LG2<F_LG1. Here, when the composite focal length of the first lens 101 and the second lens 102 in the optical system 1000 is F12 and the composite focal length of the third lens 103 to the fourth lens 104 is F34, the following condition may satisfy: F12<F34 and the following conditions may satisfy: F13, F47>0. In addition, the following conditions may satisfy: F_LG1<F12<F_LG2 and F_LG1<F34<F_LG2. Here, F_LG1 is the focal length of the first lens 101 and may be defined as F1, and F_LG2 is the composite focal length of the second lens 102 to the fourth lens 104 and may be defined as F24. In addition, the number of lenses having negative (−) power on the optical system 1000 may be greater than the number of lenses having positive (+) power. The number of lenses having negative (−) power may be more than 50% of the total number of lenses, and may be in the range of, for example, 51% to 70%.

The lens unit 100 may be a mixture of spherical lenses and aspherical lenses. The average effective diameter of the aspherical lens may be smaller than the average effective diameter of the spherical lens. The average effective diameter of the aspherical lens surface may be smaller than the average effective diameter of the spherical lens surface. In addition, the difference between the average effective diameter of the aspherical lens and the average effective diameter of the spherical lens may be 0.3 mm or more, for example, in the range of 0.3 mm to 1.6 mm. Accordingly, when at least one aspherical lens is arranged in the camera module, the weight of the camera module may be reduced and distortion of the peripheral region may be reduced. In addition, the difference in effective diameter between the aspherical lens and the spherical lens may be reduced, thereby preventing deterioration of assembly.

The first lens group LG1 refracts light incident through the object side in the direction of the optical axis, and the second lens group LG2 refracts light emitted through the first lens group LG1 to the peripheral region of the image sensor 300. The optical axis distance between the first lens group LG1 and the second lens group LG2 may be 0.8 mm or more, for example, 2 mm or less.

In the lens unit 100, the average Abbe number of the spherical material lens may be smaller than the average Abbe number of the aspherical lens. Since the lens closest to the object is arranged to have a high Abbe number and a low refractive index, the chromatic dispersion of incident light may be suppressed in an optical system with a small TTL and the field of view may be widened compared to the focal length. The sum of the refractive indices of the lenses of the lens unit 100 of the embodiment may be 10 or less, for example, in the range of 6 to 10, and the average of the refractive indices may be in the range of 1.58 to 1.68. The sum of the Abbe numbers of each of the lenses may be 220 or more, for example, in the range of 220 to 320, and the average of the Abbe numbers may be 49 or more, for example, in the range of 49 to 59. The sum of the center thicknesses of the entire lens may be 6 mm or less, for example, in the range of 3 mm to 6 mm or in the range of 4 mm to 6 mm. The average of the center thicknesses of the entire lens may be 1.5 mm or less, for example, in the range of 0.8 mm to 1.5 mm. The sum of the center distances between the lenses on the optical axis OA may be 3.6 mm or more, for example, in the range of 3.6 mm to 4.6 mm or 4.1 mm to 5.1 mm, and may be less than the sum of the center thicknesses of the lenses. In addition, the average value of the effective diameter of each lens surface of the lens unit 100 may be provided as 5 mm or less, for example, in the range of 2 mm to 5 mm or 3 mm to 5 mm. The difference between the maximum and minimum effective diameters may have a difference of 4 mm or less. Therefore, an optical system in which the difference in the effective diameter of each lens is not large may be provided, and the assembling performance of the lenses assembled in the lens barrel may be improved.

In the lens unit 100, when the number of aspherical lenses is Ma, the number of lenses having an effective diameter smaller than the diagonal length of the image sensor 300 is Mb, and the number of lenses having negative power is Mc, the following condition may satisfy: Mb≤Ma<Mc, and preferably, the following condition may satisfy: Mb<Ma. In the lens unit 100, the number of lens surfaces having an aspherical surface is Ma1, the number of lens surfaces having an effective diameter smaller than the diagonal length of the image sensor 300 is Mb1, and the number of lenses having negative power is Mc, the following condition may satisfy: Mb1≤Ma1<Mc, and preferably, the following condition may satisfy: Mb1<Ma1. The lens surfaces are the object-side surface and the sensor-side surface of each lens. In the above lens unit 100, the number of spherical lenses is Ga, the number of lenses having an effective diameter smaller than the diagonal length of the image sensor 300 is Gb, and the number of lenses having positive power is Gc, when the following condition may satisfy: Gc<Ga≤Gc, and preferably the following condition may satisfy: Ga<Gc.

The F number of the optical system or camera module according to the embodiment of the invention may be 2.4 or less, for example, in the range of 1.4 to 2.4 or in the range of 1.8 to 2.3. In the optical system according to the embodiment of the invention, the maximum field of view (diagonal FOV) may be less than 85 degrees, for example, more than 45 degrees and less than 85 degrees, or in the range of 50 degrees to 80 degrees. The horizontal field of view FOV_H of the vehicle optical system in the Y-axis direction may be more than 40 degrees and less than 60 degrees, for example, in the range of 45 degrees to 59 degrees. The horizontal field of view FOV_H is a field of view based on the horizontal length of the sensor. Accordingly, it is possible to suppress the change in the focus image position due to temperature change, and provide a vehicle camera in which various aberrations are well corrected. When the diagonal field of view of the optical system 1000 is 50 to 80 degrees, if at least one aspherical lens and at least three spherical lenses are provided in the optical system, the average center thickness of the spherical lens may be provided thicker than the average center thickness of the aspherical lenses. Accordingly, the aspherical lens and spherical lens made of glass can suppress the change in optical performance due to temperature change from low temperature to high temperature.

The optical system 1000 or the camera module may include an image sensor 300. The image sensor 300 may detect light and convert it into an electrical signal. The image sensor 300 can detect light that has sequentially passed through the lens unit 100. The image sensor 300 may include a device that can detect incident light, such as a CCD (Charge Coupled Device) or a CMOS (Complementary Metal Oxide Semiconductor). Here, the diagonal length of the image sensor 300 is 95% or more of the maximum effective diameter of the lenses, for example, in the range of 95% to 130%, and for example, in the range of 104% to 124%.

The optical system 1000 or the camera module may include an optical filter 500. The optical filter 500 may be disposed between the second lens group LG2 and the image sensor 300. The optical filter 500 may be disposed between the lens closest to the sensor side among the lenses of the lens unit 100 and the image sensor 300. For example, the optical system 100 may be disposed between the last lens and the image sensor 300. The cover glass 400 is arranged between the optical filter 500 and the image sensor 300 and may protect the upper portion of the image sensor 300 and prevent the reliability of the image sensor 300 from being deteriorated. The cover glass 400 may be removed. The optical filter 500 may include an infrared filter or an infrared cut-off filter (IR cut-off). The optical filter 500 may pass light of a set wavelength band and filter light of a different wavelength band. When the optical filter 500 includes an infrared filter, it may block radiant heat emitted from external light from being transmitted to the image sensor 300. In addition, the optical filter 500 may transmit visible light and reflect infrared light. The optical filter 500 may pass wavelengths of 920 nm or more, and for example, can pass wavelength bands of 920 nm to 960 nm.

Since the embodiment is an optical system applied to a vehicle camera, the first lens 101 may be provided as a glass material even though it is designed using an aspherical lens and a spherical lens together. This is because the glass material has the advantage of being scratch-resistant and not sensitive to external temperature compared to a plastic material. Since the first lens 101 has a convex shape toward the driver inside the vehicle, it can more effectively prevent foreign substances from accumulating or scratches, and can improve the incidence efficiency. Accordingly, the reliability of the driver monitoring camera module may be improved. The optical system 1000 according to the embodiment can further include a reflective member (not shown) for changing the path of light. The reflective member may be implemented as a prism that reflects the incident light of the first lens group LG1 toward the lenses.

Hereinafter, an optical system according to an embodiment will be described in detail.

Hereinafter, an optical system according to an embodiment of the invention will be described. Referring to FIGS. 1 to 3, an optical system 1000 according to an embodiment includes a lens unit 100, and the lens unit 100 may include a first lens 101 to a fifth lens 105. The first to fifth lenses 101, 102, 103, 104, and 105 may be sequentially aligned along an optical axis OA. Light corresponding to information about an object may pass through the first lens 101 to the fifth lens 105 and an optical filter 500 and be incident on an image sensor 300. The first lens 101 is a lens of the first lens group LG1 and is the lens closest to the object side. The fifth lens 105 is the lens closest to the image sensor 300 in the second lens group LG2 or lens unit 100. The second to fifth lenses 102, 103, 104, and 105 may be the second lens group LG2.

As the composite focal lengths of the lenses, F12, F24, and F34 may satisfy the following conditions. F12 is the composite focal length of the first and second lenses, F34 is the composite focal length of the third and fourth lenses, and F25 is the composite focal length of the second to fifth lenses. The power is the reciprocal of the focal length.

$$F 25 > 0 \qquad Condition 1$$

$$F 35 > 0 \qquad Condition 2$$

$$F 12 < 0 \qquad Condition 3$$

$$F 34 > 0 \qquad Condition 4$$

$$F 35 < \vert F 12 \vert \qquad Condition 5$$

$$F 25 < \vert F 12 \vert \qquad Condition 6$$

The first lens 101 may have positive (+) or negative (−) power on the optical axis OA. The first lens 101 may have negative (−) power. The first lens 101 may include a plastic material or a glass material, and can be, for example, a glass material. The first lens 101 made of the glass material can reduce changes in the center position and curvature radius due to temperature changes according to the surrounding environment, and can protect the incident side surface of the optical system 1000.

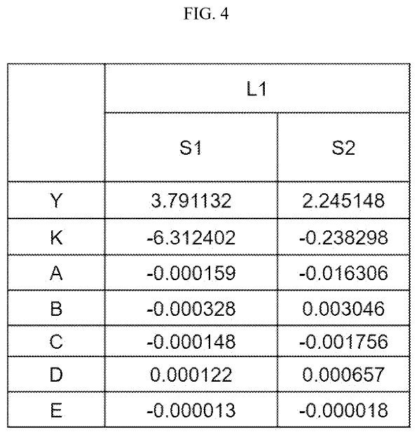

An object-side first surface S1 of the first lens 101 based on the optical axis may have a convex shape, and a sensor-side second surface S2 may have a concave shape. The first lens 101 may have a meniscus shape that is convex from the optical axis to the object side. In contrast, the first surface S1 may have a concave shape on the optical axis OA, and the second surface S2 may have a convex shape. The first surface S1 and the second surface S2 of the first lens 101 may be aspherical on the optical axis, and the aspherical coefficients may be provided as L1S1 and L1S2 of FIG. 4. Since the first lens 101 is provided as an aspherical lens made of glass, when the temperature changes to low or high temperature, the movement of the optical axis may be suppressed, thereby preventing a deterioration of the optical performance. In addition, even if the thickness of the lens is designed to be thin due to the aspherical material made of glass, the distortion of the peripheral portion of the lens may be improved. In contrast, when the first lens 101 is a spherical lens, the power may be negative.

The first lens 101 has a convex first surface S1 and a concave second surface S2 on the optical axis, so that the incident light may be refracted in a direction close to the optical axis. Accordingly, the edge distance between the first and second lenses 101 and 102 and the effective diameter of the second lens 102 may be reduced. Since the first lens 101 is arranged so that the edge thickness is thicker than the center thickness, it may be insensitive to assembly tolerance. Being insensitive to assembly tolerance means that even if the assembly is assembled with a slight difference compared to the design, the optical performance may not be significantly affected.

An aperture stop ST may be disposed on the perimeter between the first lens 101 and the second lens 102. An aperture stop ST may be disposed on the perimeter of the object-side surface of the second lens 102. The aperture stop ST may be disposed closer to the object-side surface of the second lens 102 than to the sensor-side surface of the first lens 101. Alternatively, the aperture stop ST may be disposed around the sensor-side surface of the second lens 102 or around the object-side surface of the first lens 101. Since the aperture stop ST is disposed around the perimeter between the first and second lenses 101 and 102, the difference in effective diameter between the first and second lenses 101 and 102 may be reduced. The first lens 101 and the second lens 102 on both sides of the aperture stop ST may have powers having the same sign. The difference in power between the first lens 101 and the second lens 102 on both sides of the aperture stop ST may be 10% or less of the average power of the two lenses.

The second lens 102 may be disposed between the first lens 101 and the third lens 103. The second lens 102 may have positive (+) or negative (−) power on the optical axis OA. The second lens 102 may have negative (−) power. The second lens 102 may include a plastic or glass material. For example, the second lens 102 may be provided as a glass material. The object-side third surface S3 of the second lens 102 on the optical axis OA may be concave, and the sensor-side fourth surface S4 may have a convex shape. The second lens 102 may have a convex meniscus shape toward the sensor side on the optical axis. Alternatively, the third surface S3 may be convex, and the fourth surface S4 may be concave. In contrast, the second lens 102 may have a concave shape on both sides. The second lens 102 may be provided as a spherical lens made of glass. The third surface S3 and the fourth surface S4 may be spherical. Since the second lens 102 is arranged closest to the sensor side of the aperture stop ST, the second lens 102 may have a minimum effective diameter among the first to fifth lenses 101-105. The center distance between the first and second lenses 101 and 102 may be greater than the sum of the center thicknesses of the first and second lenses 101 and 102. The edge distance between the first and second lenses 101 and 102 may be less than the sum of the center thicknesses of the first and second lenses 101 and 102. Here, the edge distance is the optical axis distance between the end of the effective region of the sensor-side surface of the object-side lens and the end of the effective region of the object-side surface of the sensor-side lens among the two adjacent lenses.

The effective diameters of the first and second lenses 101 and 102 arranged on the object-side and sensor-side of the aperture stop ST may be smaller than the effective diameters of the third to fifth lenses 103, 104, and 105. In addition, the effective diameters of the first and second lenses 101 and 102 adjacent to the aperture stop S5 may be smaller than the effective diameter of the second lens 102 closer to the aperture stop ST than the effective diameter of the first lens 101, and the effective diameter of the first lens 101 may be smaller than the effective diameter of the third lens 103 among the third to fifth lenses 103, 104, and 105 closer to the aperture stop ST. When an aperture stop ST is placed between the first and second lenses 101 and 102 to reduce TTL, the effective diameter of the two lenses adjacent to the aperture stop ST may be designed to be smaller than the effective diameters of the other lenses. In addition, since the effective diameter of the first and second lenses 101 and 102 is small, the center thickness is thin, and the distance between the first and second lenses 101 and 102 is reduced, the TTL may be reduced, but distortion and aberration of the light traveling through the first and second lenses 101 and 102 may occur. Accordingly, in order to suppress the distortion and aberration of the light, the first lens 101 may be provided as an aspherical lens. In addition, the distortion and aberration that occur to reduce TTL are corrected by adjusting the refractive index, thickness, Abbe number, curvature radius of the third to fifth lenses 103, 104, and 105 and the distance between adjacent lenses. The power, distance, and thickness of the third and fourth lenses 103 and 104 to reduce distortion/aberration will be described later. If the aperture stop ST is disposed on the object side of the first lens 101, the TTL may be further reduced, but in this structure, the aberration and distortion of the optical system become more severe, and it is difficult to correct the aberration and distortion with other lenses, or the TTL may increase and the size of the camera module may also increase.

The third lens 103 may have positive (+) or negative (−) power on the optical axis OA. The third lens 103 may have positive (+) power. The third lens 103 may include a plastic or glass material. For example, the third lens 103 may be made of glass. The power of the third lens 103 may be disposed to be at least twice the absolute value of the powers of the first, second, and fifth lenses 101, 102, and 105, thereby correcting distortion and aberration. The object-side fifth surface S5 of the third lens 103 on the optical axis may have a convex shape, and the sensor-side sixth surface S6 may have a convex shape. The third lens 103 may have a convex shape on both sides in the optical axis. In contrast, the third lens 103 may have a convex meniscus shape toward the sensor, or a concave shape on both sides in the optical axis.

The third lens 103 may be a spherical lens made of glass. The center thickness of the third lens 103 may be at least two times or at least three times the center thickness of the first and second lenses 101 and 102. Since the third lens 103 has a convex shape on both sides, the center thickness may be greater than the edge thickness. The effective diameter of the third lens 103 may be greater than the effective diameter of the first and second lenses 101 and 102. Since the object-side surface of the third lens 103 has a convex shape on the optical axis and the sensor-side surface of the second lens 102 has a convex shape, the center distance between the second and third lenses 102 and 103 may be the minimum among the center distances of the lenses.

The fourth lens 104 may have positive (+) or negative (−) power on the optical axis OA. The fourth lens 104 may have positive (+) power. The fourth lens 104 may include a plastic or glass material. For example, the fourth lens 104 may include a glass material. The power of the fourth lens 104 may be disposed to be more than twice the absolute value of the power of the first, second, and fifth lenses 101, 102, and 105, thereby correcting distortion and aberration. The object-side seventh surface S7 of the fourth lens 104 on the optical axis may be convex, and the sensor-side eighth surface S8 may have a convex shape. The fourth lens 104 may have a shape in which both sides are convex on the optical axis. Alternatively, the fourth lens 104 may have a meniscus shape convex toward the sensor side or a concave shape on both sides. The fourth lens 104 may be provided as a spherical lens made of glass. At least one of the seventh surface S7 and the eighth surface S8 of the fourth lens 104 may be provided without a critical point. The fourth lens 104 may be the n−1th lens and may have the largest effective diameter among the lenses. The center thickness of the fourth lens 104 may be at least twice or at least three times the center thickness of the first and second lenses 101 and 102. The center thickness of the third and fourth lenses 103 and 104 may be at least twice or at least three times the minimum center thickness of the lenses.

Since the sensor-side surface of the third lens 103 has a convex shape on the optical axis and the object-side surface of the fourth lens 104 has a convex shape on the optical axis, the center distance between the third and fourth lenses 103 and 104 may be greater than the sum of the center thicknesses of the first and second lenses 101 and 102. In addition, the edge distance between the third and fourth lenses 103 and 104 may be greater than the center distance between the third and fourth lenses 103 and 104. This is because the sensor-side surface of the third lens 103 has a smaller curvature radius than the curvature radius of the object-side surface and is provided in a convex curved shape, so that the third lens 103 can refract light to the periphery of the fourth lens 104 having the maximum effective diameter. Since the fourth lens 104 has a convex shape on both sides, the center thickness may be larger than the edge thickness. The difference between the absolute values of the curvature radius of the object-side surface and the curvature radius of the sensor-side surface of the fourth lens 104 may be smaller than the difference between the absolute values of the curvature radius of the object-side surface and the curvature radius of the sensor-side surface of the third lens 103. The difference between the absolute values of the curvature radius of the object-side surface and the curvature radius of the sensor-side surface of the fourth lens 104 may be the smallest among the lenses. The power of each of the third and fourth lenses 103 and 104 arranged sequentially along the optical axis is arranged to be at least twice the absolute value of the power of the first, second and fifth lenses 101, 102, and 105, thereby correcting distortion and aberration occurring in the first and second lenses 101 and 102. Among the third and fourth lenses 103 and 104, the power of the third lens 103 adjacent to the first and second lenses 101 and 102 may be the greatest.

In order to correct the distortion and aberration caused by the first and second lenses 101 and 102, the center distance between the second and third lenses 102 and 103 may be reduced, the center thickness of the third and fourth lenses 103 and 104 may be provided to be thicker than the other lenses, and the center distance between the third and fourth lenses 103 and 104 may be set to be larger than the center distance between the first and second lenses 101 and 102. The third and fourth lenses 103 and 104 can correct the distortion and aberration of light passing through the first and second lenses 101 and 102 in a direction in which they are removed, and then refract the light to the entire region of the fifth lens 105.

The fifth lens 105 may have positive (+) or negative (−) power on the optical axis OA. The fifth lens 104 may have negative (−) power. The fifth lens 105 may include a plastic or glass material. For example, the fifth lens 105 may include a glass material. The object-side ninth surface S9 of the fifth lens 105 on the optical axis may be concave, and the sensor-side tenth surface S10 may have a convex shape. The fifth lens 105 may have a convex shape toward the sensor side on the optical axis. Alternatively, the fifth lens 105 may have a meniscus shape or a concave shape on both sides that is convex toward the object side on the optical axis. The fifth lens 105 may be provided as a spherical lens made of glass. At least one of the ninth surface S9 and the tenth surface S10 of the fifth lens 105 may be provided without a critical point. The fifth lens 105 may be the n-th lens and may have the second largest effective diameter among the lenses. The center thickness of the fifth lens 105 may be ½ or ⅓ times or less than the center thickness of the third and fourth lenses 103 and 104. The center thickness of the fifth lens 105 may have a difference of 10% or less from the center thickness of the first and second lenses 101 and 102. The fifth lens 105 is disposed so that the edge thickness is thicker than the center thickness, so that light may be refracted to the entire region of the image sensor 300 through the periphery.

Since the sensor-side surface of the fourth lens 104 has a convex shape on the optical axis, and the object-side surface of the fifth lens 105 has a concave shape on the optical axis, the center distance between the fourth and fifth lenses 104 and 105 may be the maximum among the center distances between the lenses. In addition, the distance between the fourth and fifth lenses 104 and 105 may be such that the edge distance is smaller than the center distance. The fifth lens 105 may be a spherical lens closest to the image sensor 300. By arranging the spherical lens as the lens closest to the image sensor 300, the assemblability may be improved compared to an aspherical lens. Since the object-side surface of the fifth lens 105 has a curved shape in which the edge is adjacent to the end of the effective region of the fourth lens 104 and the center is concave, light refracted through the fourth lens 104 may be incident. Accordingly, the center distance between the fifth lens 105 and the fourth lens 104 may be secured to the maximum, and an increase in the effective diameter of the fifth lens 105 may be suppressed. In addition, since the sensor-side surface of the fifth lens 105 is provided in a convex curved shape, light may be refracted to the entire region of the image sensor 300 even without an aspherical surface. As another example, the fifth lens 105 may be a glass lens having an aspherical surface.

Referring to FIG. 2, at least one of the ninth surface S9 and the tenth surface S10 of the fifth lens 105 may be provided without a critical point. The critical point is a point where the tendency of the Sag value changes. That is, a point where the Sag value increases and then decreases, or a point where the Sag value decreases and then increases. The Sag value is the optical axis distance between a straight line perpendicular to the center of each lens surface and the lens surface, and the Sag value has a positive value at a position located on the sensor side relative to the center of each lens surface, and has a negative value at a position located on the object side relative to the center of each lens surface. When expressed as an absolute value for the Sag value, the maximum value of Sag51 may be greater than the maximum values of Sag41, Sag42, and Sag52. Sag51 is an optical axis distance between the object-side surface of the fifth lens 105 and a straight line perpendicular to the center of the object-side surface of the fifth lens 105, Sag41 is an optical axis distance between the object-side surface of the fourth lens 104 and a straight line perpendicular to the center of the object-side surface, Sag42 is an optical axis distance between the sensor-side surface of the fourth lens 104 and a straight line perpendicular to the center of the sensor-side surface, and Sag52 is an optical axis distance between the sensor-side surface of the fifth lens 105 and a straight line perpendicular to the center of the sensor-side surface of the fifth lens 105.

In addition, the Sag values of the object-side seventh surface S7 and the sensor-side eighth surface S8 of the fourth lens 104 may have different signs and may have a difference of less than 0.2 mm, for example, the Sag values of the seventh and eighth surfaces S7 and S8 may be less than 0.2 mm at 0.1 mm, 0.2 mm, 1 mm, 2 mm, 3 mm, an end or an edge from the optical axis. In addition, the fourth lens 104 may have an absolute value of the Sag values of the seventh and eighth surfaces S8 at a distance D1 of ½ of the effective radius from the optical axis of less than 0.2 mm. The absolute values of the Sag values of the seventh and eighth surfaces S8 may gradually increase on the optical axis toward the edge, and may have the same value at the same distance from the optical axis.

BFL (Back focal length) is the optical axis distance from the image sensor 300 to the center of the sensor-side surface of the last lens. The BFL may be 1.5 mm or more, and can secure an installation space for the optical filter 500, or an installation space for the optical filter 500 and the cover glass 400. CT4 is a center thickness or optical axis thickness of the fourth lens 104, and ET4 is an edge thickness of the fourth lens 104. CT5 is a center thickness or optical axis thickness of the fifth lens 105, and ET5 is an edge thickness of the fifth lens 105. The edge thickness is the distance in the optical axis direction between the object-side surface and the sensor-side surface at the end of the effective region of each lens. CG4 is an optical axis distance (i.e., center gap) from the center of the sensor-side surface of the fourth lens 104 to the center of the object-side surface of the fifth lens 105. That is, CG4 is the distance from the center of the eighth surface S8 to the center of the ninth surface S9. EG4 is the optical axis distance (i.e., edge gap) from the edge of the sensor-side surface of the fourth lens 104 to the edge of the object-side surface of the fifth lens 105.

In the optical system 1000, at least one lens having an aspherical surface has an effective diameter smaller than the average effective diameter of spherical lenses and is arranged closest to the object side, so that light may be guided to the entire region of the image sensor through a small number of lens optical systems. The first lens 101 may be disposed on the object side of the aperture stop ST, and the second lens 102, the third lens 103, and the fourth and fifth lenses 104 and 105 may be disposed on the sensor side of the aperture stop ST. Here, the effective diameters of the first lens 101 to the fifth lens 105 are defined as CA1, CA2, CA3, CA4, and CA5, and the effective diameters of the object-side surface and the sensor-side surface of the first lens 101 to the fifth lens 105 may be defined as CA11, CA12, CA21, CA22, CA31, CA32, CA41, CA42, CA51, and CA52. When the aperture stop ST is arranged on the object-side surface of the second lens 102, the following conditions may be satisfied.

$$CA 2 < CA 1 < CA 3 < CA 4 < CA 5 \qquad Condition 1$$

$$( CA 4 - CA 5 ) < ( CA 1 - CA 2 ) \qquad Condition 2$$

$$CA 2 < ImgH < CA 4 < ( 2 * ImgH ) \qquad Condition 3$$

$$CA 21 < CA 11 < CA 32 < CA 42 \qquad Condition 4$$

$$CA 51 < CA 41 < CA 52 \qquad Condition 5$$

Since the second lens 102 disposed on the sensor side of the aperture stop ST has negative power (F2<0), the second lens 102 can refract the incident light. In addition, since the third lens 103 has a convex shape on both sides, it can refract the light toward the edge of the fourth lens. Accordingly, the yield by weight of the optical system may be prevented from decreasing by the second and third lenses 102 and 103 and the production efficiency may be improved. Here, the composite focal length of the second to fifth lenses 102-105 disposed on the sensor side of the aperture stop ST may have a positive value, and may reduce the TTL within the field of view range.

The distance between the first lens 101 and the second lens 102 may gradually decrease from the center to the edge. The distance between the second lens 102 and the third lens 103 may gradually increase from the center to the edge. This distance may gradually increase from the optical axis to the edge due to the convex shape of the sensor-side surface of the second lens 102 and the convex shape of the object-side surface of the third lens 103.

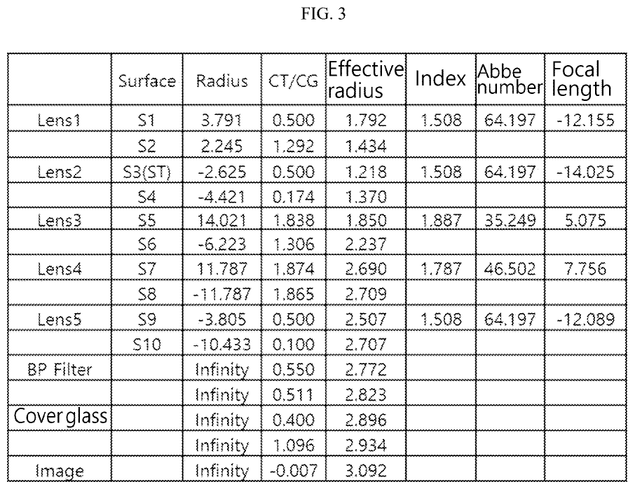

FIG. 3 is an example of lens data of the optical system of the embodiment of FIG. 1. As shown in FIG. 3, the curvature radius of the first to fifth lenses 101, 102, 103, 104, and 105 on the optical axis OA, the center thickness CT of the lenses, the center distance CG between adjacent lenses, the refractive index at the d-line, the Abbe number, and the size of the effective radius (e.g., Semi-aperture) may be set. When the curvature radius of each lens in the optical axis is expressed as an absolute value, the curvature radius of each of the first to fifth lenses 101-105 on the optical axis OA may be 30 mm or less, for example, in the range of 1 mm to 30 mm or in the range of 1 mm to 20 mm. In addition, the difference in the curvature radius of two adjacent lens surfaces may be less than 30 mm, for example, in the range of 0.1 mm to 25 mm or in the range of 0.1 mm to 15 mm. Accordingly, light may be guided without increasing the difference in curvature radius of an optical system 1000 having six or less lenses. In absolute values, the curvature radius difference between the first and second surfaces S1 and S2 is 5 mm or less, the curvature radius difference between the second and third surfaces S2 and S4 is 3 mm or less, the curvature radius difference between the third and fourth surfaces S3 and S4 is 5 mm or less, the curvature radius difference between the fourth and fifth surfaces S4 and S5 is 15 mm or less, the curvature radius difference between the fifth and sixth surfaces S5 and S6 is 15 mm or less, the curvature radius difference between the sixth and seventh surfaces S6 and S7 is 15 mm or less, the curvature radius difference between the seventh and eighth surfaces S7 and S8 is 1 mm or less, the curvature radius difference between the seventh and ninth surfaces S8 and S9 is 15 mm or less, and the curvature radius difference between the ninth and tenth surfaces S9 and S10 may be 15 mm or less. Here, the curvature radius of the glass lens may be 5% or more of the effective radius, and may be provided in a range of, for example, 5% to 95%.

When the curvature radius of each lens is expressed as an absolute value on the optical axis, the curvature radius of the fifth surface S5 of the third lens 103 may be the largest among the curvature radii of the lenses. Either the curvature radius of the second surface S2 of the first lens 101 or the third surface S3 of the second lens 102 may be the smallest among the lenses. The maximum curvature radius may be less than 30 mm, for example, 25 mm or less, and may be 15 times or less, for example, 5 to 15 times, of the minimum curvature radius. The curvature radius of the first lens 101, which is an aspherical lens, may be smaller than the curvature radius of at least one or all of the second to fifth lenses 102-105 made of a spherical material. Here, the curvature radius is an average of the absolute values of the curvature radii of the object-side surface and the sensor-side surface of each lens.

When expressed in an absolute value, the curvature radius of the first lens 101 disposed on the object side of the aperture stop ST in the optical axis may be smaller than the curvature radius of the second lens 102 disposed on the sensor side of the aperture stop ST. When expressed in an absolute value, the curvature radius of the fourth lens 104 on the optical axis may be larger than the curvature radius of the third lens 103. When expressed in an absolute value, the difference in curvature radius between the object-side surface and the sensor-side surface of the third lens 103 is larger than the difference in curvature radius between the object-side surface and the sensor-side surface of the fourth lens 104 and may be larger than the difference in curvature radius between the object-side surface and the sensor-side surface of the fifth lens 105. The difference in curvature radius between the object-side surface and the sensor-side surface of the third lens 103 may be the largest among the differences in curvature radius between the object-side surface and the sensor-side surface of each lens.

If the first lens 101 is designed as an aspherical surface made of glass, it may satisfy thermal compensation and improve optical performance, but may not be as easy to assemble as a spherical lens, and the optical characteristics of lenses disposed on the sensor side may be affected due to the aspherical first lens 101. If the first lens is a spherical lens, even if the optical characteristics of the first lens are affected, the curvature radius of the first lens may not be significantly changed due to the spherical characteristics. The invention designs the curvature radius of the first lens 101 having an aspherical surface to be 10 m or less and the effective diameter to be small, so that assembly may be easy, and even if it is assembled slightly tilted from the optical axis, the effect on the lenses on the sensor side may be minimal. Since the third to fifth lenses 103-105 are provided as spherical surfaces, the difference in curvature radius between the object-side surface and the sensor-side surface may not be large, and the assembly may be improved by a large effective diameter, and the influence on optical characteristics may be reduced.

The curvature radii of the first and second surfaces S1 and S2 of the first lens 101 are defined as L1R1 and L1R2, the curvature radii of the ninth and tenth surfaces S9 and S10 of the fifth lens 105 are defined as L5R1 and L5R2, and the curvature radii of each lens surface of the second, third, and fourth lenses 102, 1031, and 104 may be defined as L2R1, L2R2, L3R1, L3R2, L4R1, and L4R2. The ratio of the curvature radii of the object-side surface and the sensor-side surface of each lens is as follows.

$$1 < L 1 R 1 / L 1 R 2 < 3 \qquad Condition 1$$

$$0 < L 2 R 1 / L 2 R 2 < 1 \qquad Condition 2$$

$$1.2 < \vert L 3 R 1 / L 3 R 2 \vert < 5 ( provided that L 3 R 1 > 0 , L 3 R 2 < 0 ) \qquad Condition 3$$

$$0.5 < \vert L 4 R 1 / L 4 R 2 \vert < 1.5 \qquad Condition 4$$

$$0 < \vert L 5 R 1 / L 5 R 2 \vert < 1 \qquad Condition 5$$

$$0 mm \leq \vert L 4 R 1 \vert - \vert L 4 R 2 \vert \leq 1 mm \qquad Condition 6$$

Preferably, Condition 5 satisfies: |L4R1|−L4R2≤0.2 mm. Preferably, the absolute values of L4R1 and L4R2 may be equal to each other or have a difference less than the tolerance of the curvature radius. The tolerance of the curvature radius may be ±0.05 mm. If the difference in curvature radius between the object-side seventh surface S7 and the sensor-side eighth surface S8 of the fourth lens 104 is designed to be within the above range or tolerance, the object-side surface and the sensor-side surface may be assembled without distinction, thereby improving the convenience of assembly. If the difference in curvature radius between the object-side seventh surface S7 and the sensor-side eighth surface S8 of the fourth lens 104 exceeds 0.2 mm, it may be difficult to distinguish between the two lens surfaces S7 and S8 and the problem may occur that they are assembled in reverse.

In addition, if the absolute value of the curvature radius of the object-side surface of the i-th lens is LiR1 and the absolute value of the curvature radius of the sensor-side surface is LiR2, the value of LiR1/LiR2 (i=1˜5) may be maximum when i is 1 and minimum when i is 5. In addition, the difference in curvature radius between the adjacent aspherical lens surface and the spherical lens surface may satisfy the following condition.

$$0.5 < \vert L 1 R 2 \vert / L 2 R 1 < 1.4 \qquad Condition 7$$

The difference in curvature radius between the spherical lens surface and the aspherical lens surface is set to 1 mm or less, for example, in the range of 0.1 mm to 1 mm, so that chromatic aberration between the lens surfaces may be corrected.

When the center thickness of the first to fifth lenses 101-105 is defined as CT1-CT5, and the edge thickness of the first to fifth lenses 101-105 is defined as ET1-ET5, a sum of the center thicknesses of the first to fifth lenses 101-105 may be defined as ΣCT, and a sum of the edge thicknesses of the first to fifth lenses 101-105 may be defined as ΣET. In terms of the thickness of the lenses, the center thickness CT4 of the fourth lens 104 may be greater than the center thicknesses CT1, CT2, and CT5 of the first, second, and fifth lenses 101, 102, and 105, and preferably, may have the largest thickness among the lenses. Since the center thickness CT4 of the fourth lens 104 is the largest and the curvature radius of the sensor-side surface is the largest among the curvature radiuses of the sensor-side surfaces of each lens, the incident light may be refracted to the end of the effective region of the last lens. That is, in order to control the light path due to the TTL of 20 mm or less and the effective diameter and lens shape of the fourth lens 104, the fifth lens 105 may have a convex meniscus shape toward the sensor side.

The ratio of the center thickness and the edge thickness of each lens may satisfy the following conditions.

$$Condition 1 : 0 < CT 1 / ET 1 < 1 Condition 2 : 0 < CT 2 / ET 2 < 1$$

$$Condition 3 : 0.5 < CT 3 / ET 3 < 1.5 Condition 4 : 0.1 < CT 4 / ET 4 < 1.1$$

$$Condition 5 : 0 < CT 4 / ET 4 < 1$$

$$Condition 6 : 0.1 < \sum CT / \sum ET < 1.1 or 0.3 < \sum CT / \sum ET < 1$$

$$Condition 7 : CT 1 / \sum CT < 0.3 Condition 8 : 0.15 < CT 4 / \sum CT < 0.7$$

In the conditions, when CTi/ETi (i=1˜5), it may be maximum when i is 3 and minimum when i is 1. The difference between the center thickness and the edge thickness of each lens may be set to be more than 0.01 mm and less than 2 mm. In addition, by placing an aspherical lens in the first lens 101 and designing the ratio of center thickness to edge thickness to be the largest, it is possible to prevent assembly degradation due to the aspherical lens.

In order to provide the edge thickness of the third and fourth lenses 103 and 104 to be 0.6 mm or more, the center thickness of the third and fourth lenses 103 and 104 may be set thick, and the curvature radius of the object-side surface and the sensor-side surface may be set large. By setting the center thickness and the edge thickness difference of the fourth lens 104 to the range of Condition 4, the curvature radius difference between the object-side surface and the sensor-side surface may be designed not to be large, and the assemblability of the fourth lens 104 may be improved. In addition, the difference between the maximum center thickness and the minimum center thickness of the lenses may be 2 mm or less, for example, in the range of 0.5 mm to 2 mm or 1 mm to 1.5 mm. That is, even if the center thickness of the last spherical lens is provided thinly, the optical performance may not be degraded, and the thickness of the camera module may be provided slimly. In addition, since the difference between the center thickness and the edge thickness of each lens is not large, even if at least one lens is tilted, the influence on the optical characteristics may be reduced. In addition, the influence on the thermal characteristics between the center and the edge of each lens by the glass lenses may be reduced.

The maximum center thickness may be greater than the sum of the center thicknesses of two different lenses. For example, the following conditions may satisfy: (CT1+CT2)<CT4, (CT1+CT5)<CT4, and (CT2+CT5)<CT4. The center thickness of the third lens 103 may be greater than the sum of the center thicknesses of two different lenses. For example, the following conditions may satisfy: (CT1+CT2)<CT3, (CT1+CT5)<CT3, and (CT2+CT5)<CT3.

The center distance between the first to fifth lenses 101-105 is defined as CG1-CG4, and the sum of the center distances between the first to fifth lenses 101-105 may be defined as ECG. The center distances between adjacent two lenses among the second lens 102 to the fifth lens 105 are CG2, CG3, and CG4, which are center distances between spherical lenses. The center distance between the first and second lenses 101 and 102 is CG1, which is the center distance between the spherical lens and the aspherical lens. The center distance CG4 between the fourth and fifth lenses 104 and 105 is the maximum within the lens unit 100, and may be greater than the center distance between the aspherical and spherical lenses. The center thickness of each lens and the center distance between adjacent lenses may satisfy the following conditions.

$$Condition 1 : 0 < CT 1 / CG 1 < 1 Condition 2 : 1.5 < CT 2 / CG 2 < 4$$

$$Condition 3 : 1 < CT 3 / CG 3 < 2 Condition 4 : 0.5 < CT 4 / CG 4 < 1.5$$

$$Condition 5 : 0 < CT 5 / CG 4 < 1 Condition 6 : ( CT 1 / CG 1 ) < ( CT 4 / CG 4 ) < ( CT 3 / CG 3 )$$

$$Condition 7 : 0 < CG 3 / \sum CG < 0.5 Condition 8 : 0.5 < CT\_Max / CG\_Max < 1.5$$

By providing the maximum center thickness between the lenses to be at least twice the maximum center distance, for example, in the range of 2.1 to 4.5 times, it is possible to provide a camera module that applies an aspherical lens to the optical system without increasing the center thickness compared to the center distance of each lens. In condition 3, since the spherical third and fourth lenses 103 and 104 are provided in a convex shape on both sides, the center distance between the third and fourth lenses 104 and 105 may be reduced. Here, if the i-th center distance among the center distances between adjacent two lenses is defined as CGi, and the center thickness of the i-th lens positioned on the object side relative to CGi is defined as CTi, the following condition may be satisfied. The ratio of CTi/CGi may be maximum when i is 2 and minimum when i is 1. The following condition that the value of CTi/CGi is maximum when i is 2 may be implemented by different meniscus shapes of the spherical lens and the aspherical lens.

If the optical axis distance from the center of the object-side surface of the first lens 101 to the surface of the image sensor 300 is TTL, the following condition may be satisfied.

$$Condition 1 : 0 < CT 1 / TTL < 0.2$$

Preferably, Condition 1 may satisfy: 0.05≤CT1/TTL≤0.15. Since the first lens 101 is made of a glass material of an aspherical lens, an optical system may be designed that may satisfy thermal compensation according to temperature change by the thickness of the first lens 101 satisfying Condition 1. That is, Condition 1 may be a feature that appears by designing the first lens 101 as an aspherical glass.

$$Condition 2 : 0 < CT 2 / TTL \leq 0.15 Condition 3 : 0.15 < CT 3 / TTL < 0.5$$

$$Condition 4 : 0.1 < CT 4 / TTL < 0.3 Condition 5 : 0 < CT 5 / TTL \leq 0.15$$

The ratio of CT1/TTL in the above conditions 3 and 4 may be greater than the values in the conditions 1, 2 and 5.

In terms of the refractive index, the refractive index of the third lens 103 is the largest among the refractive indices of the lenses, and preferably, the refractive index of the third and fourth lenses 103 and 104 may be 1.7 or more. The difference in the refractive index of the third and fourth lenses 103 and 104 is 0.20 or less. When the refractive indices of the third and fourth lenses 103 and 104 are arranged to be higher than the refractive indices of the first, second, and fifth lenses 101, 102, and 105, the power of the third and fourth lenses 103 and 104 may be increased, and an increase in the curvature radius of the object-side surface and the sensor-side surface may be suppressed. Accordingly, the sensitivity of light traveling through the third and fourth lenses 103 and 104 may be lowered. The refractive indices of the third and fourth lenses 103 and 104 may be higher than the average refractive indices of the first to fifth lenses 101-105. The refractive indices of the first, second, and fifth lenses 101, 102, and 105 may be less than 1.6. By setting the refractive indices of the first to fifth lenses 101-105, color dispersion may be controlled. Since the center thickness and edge thickness of the third and fourth lenses 103 and 104 are provided thicker than those of other lenses, the curvature radius of the object-side surface and the sensor-side surface of the third and fourth lenses 103 and 104 may be suppressed from increasing. Color dispersion may be increased by the high refractive index of the third and fourth lenses 103 and 104 and the edge thickness thinner than the center thickness. The first lens 101 has a shape in which the object-side surface protrudes toward the driver, so that the amount of incident light may be increased.

In terms of the Abbe number, the Abbe number of at least one or all of the first, second, and fifth lenses 101, 102, and 105 is the largest among the lenses and may be 55 or more. The Abbe number of the third lens 103 is the smallest among the lenses. The difference between the maximum Abbe number and the minimum Abbe number may be 20 or more. By reducing the difference in Abbe number or refractive index between the object-side lens and the sensor-side lens of the aperture stop ST, it is easy to control the path of light passing through the aperture stop ST. By providing the Abbe number of the fifth lens 105 closest to the image sensor 300 higher than that of the first lens 101, the color dispersion of light passing between the glass lenses may be controlled and guided to the image sensor 300.

The focal lengths F3 and F4 of the third and fourth lenses 103 and 104 have positive power, and the focal lengths F1, F2, and F5 of the first, second, and fifth lenses 101, 102, and 105 may have negative power. Since the lenses repeatedly contract and expand as the temperature changes from low to high temperatures, the amount of contraction and expansion by the glass lenses may be reduced. When the focal length is expressed as an absolute value, the focal length of the second lens 102 is the maximum among the lenses and may be 10 mm or more. The focal length of the third lens 103 is the minimum among the lenses. The difference between the maximum focal length and the minimum focal length may be 5 mm or more. By the focal length described above, the optical system may have improved MTF characteristics, aberration control characteristics, resolution characteristics, etc. in the set field of view range, and may have good optical performance in the periphery of the field of view.

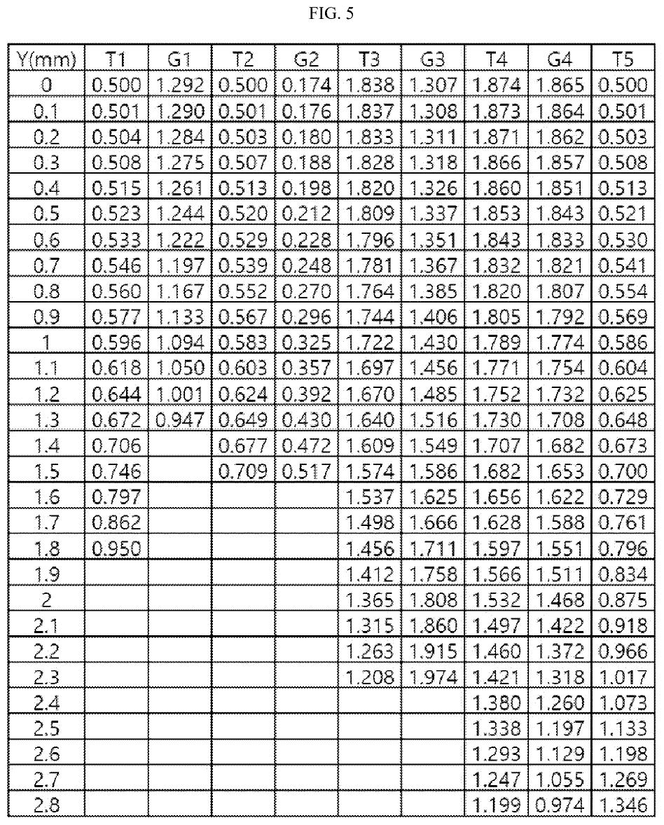

As shown in FIG. 4, among the lenses of the lens unit 100 in the embodiment, the lens surface of the first lens 101 may include an aspherical surface having a 30th-order aspherical surface coefficient. For example, the first lens 101 may include a lens surface having a 30th-order aspherical surface coefficient. As described above, an aspherical surface having a 30th-order aspherical surface coefficient (a value other than “0”) can significantly change the aspherical shape of the peripheral portion, and thus can satisfactorily correct the optical performance of the peripheral portion of the field of view (FOV). As shown in FIG. 5, the thickness T1-T5 of the first to fifth lenses 101, 102, 103, 104, and 105 and the distance G1-G4 between adjacent two lenses may be set, and the thickness T1-T5 of each lens may be expressed at intervals of 0.1 mm or more in the Y-axis direction orthogonal to the optical axis, and the distance G1-G4 between each lens may be expressed at intervals of 0.1 mm or more.

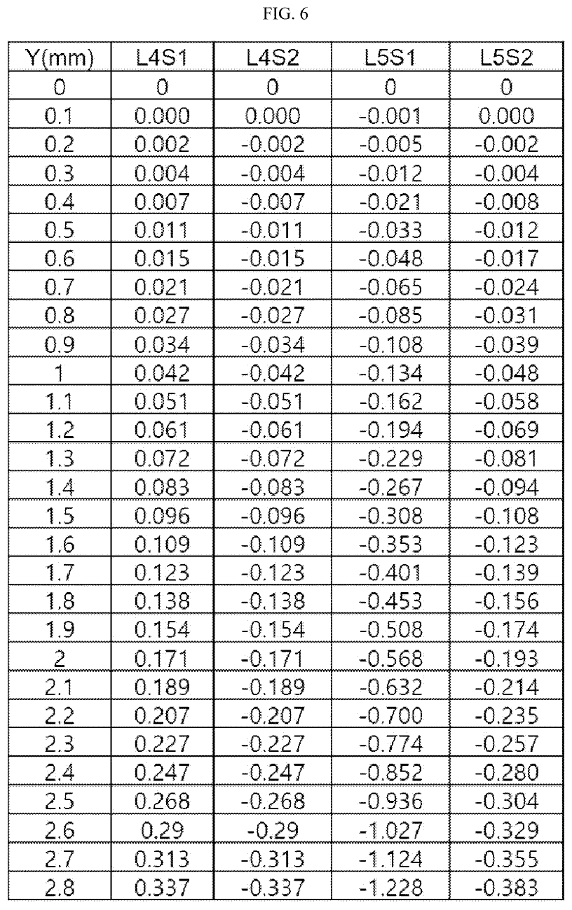

As shown in FIG. 6, when explaining the Sag value from the optical axis to the end of the effective region of the fourth and fifth lenses, it may be seen that the absolute values of the Sag values of L4S1 and L4S2, which are the object-side surface and sensor-side surface of the fourth lens 104, and the Sag value of L5S2, which is the sensor-side surface of the fifth lens 105, are smaller than the Sag value of L5S1, which is the object-side surface of the fifth lens 105. It may be seen that the absolute value of the Sag data of L5S1 is more than twice that of the Sag data of L4S1, L4S2, and L5S2.

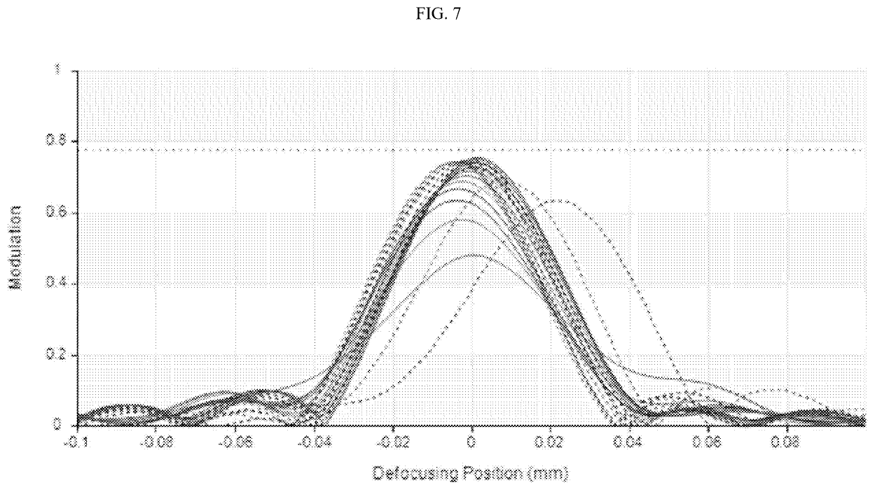

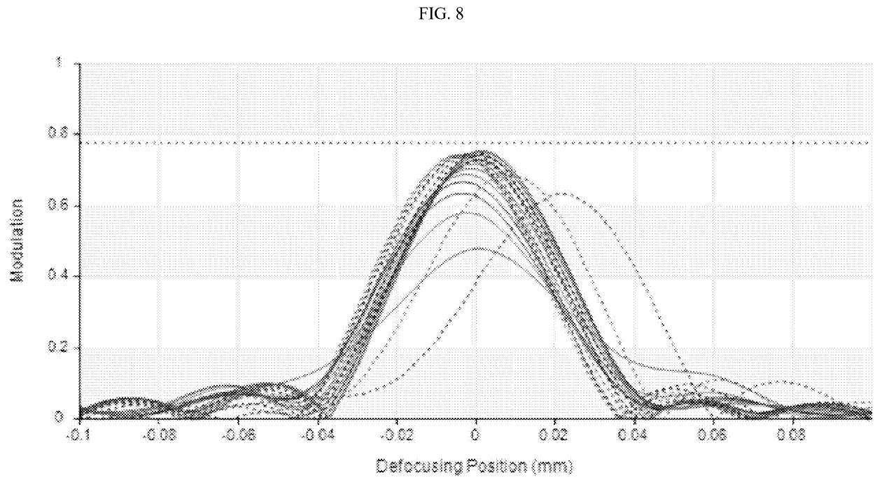

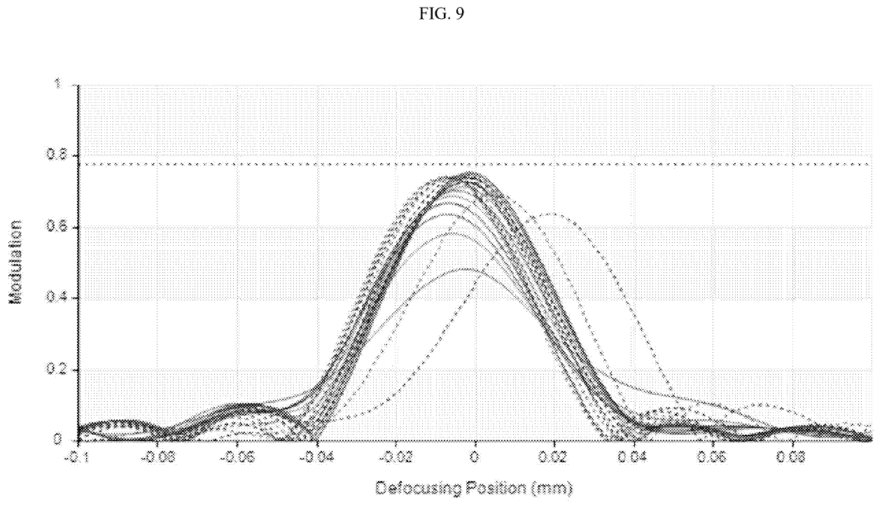

FIGS. 7 to 9 are graphs showing the diffraction MTF (Modulation transfer function) at room temperature, low temperature, and high temperature in the optical system of FIG. 1, and are graphs showing the modulation according to the spatial frequency. As shown in FIGS. 7 to 9, in the embodiment of the invention, the deviation of the MTF with respect to the room temperature and the low temperature or high temperature may be less than 10%, that is, 7% or less. In FIGS. 7 to 9, the x-axis means the defocusing position, the y-axis means the MTF, and the graphs are measured from F1 to F11 from 0.000 mm to 3.092 mm in units of 0.309 mm.

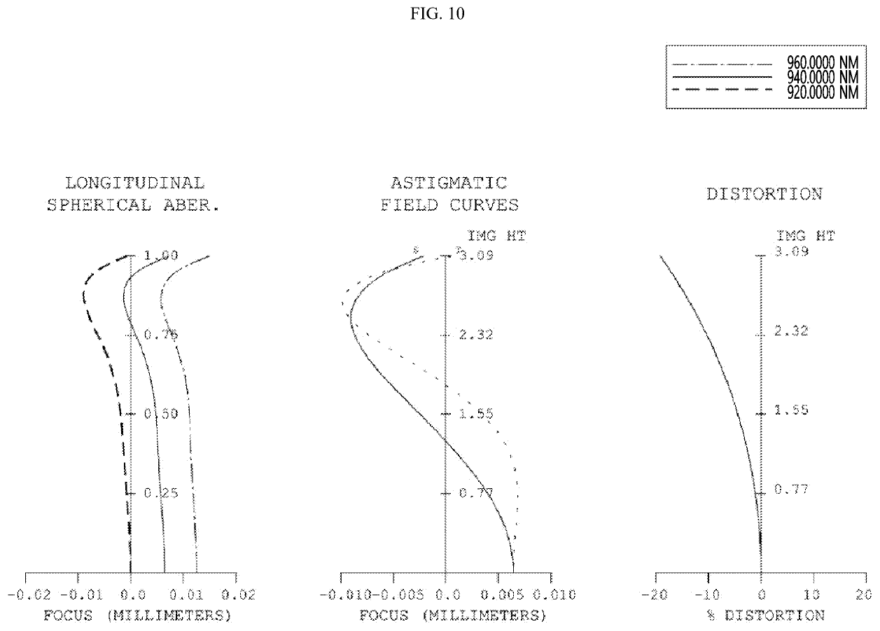

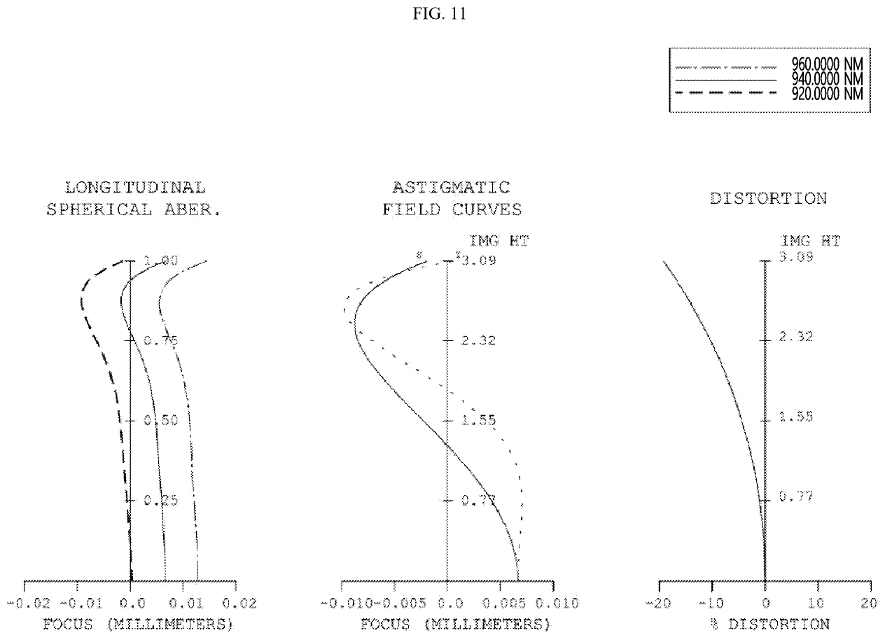

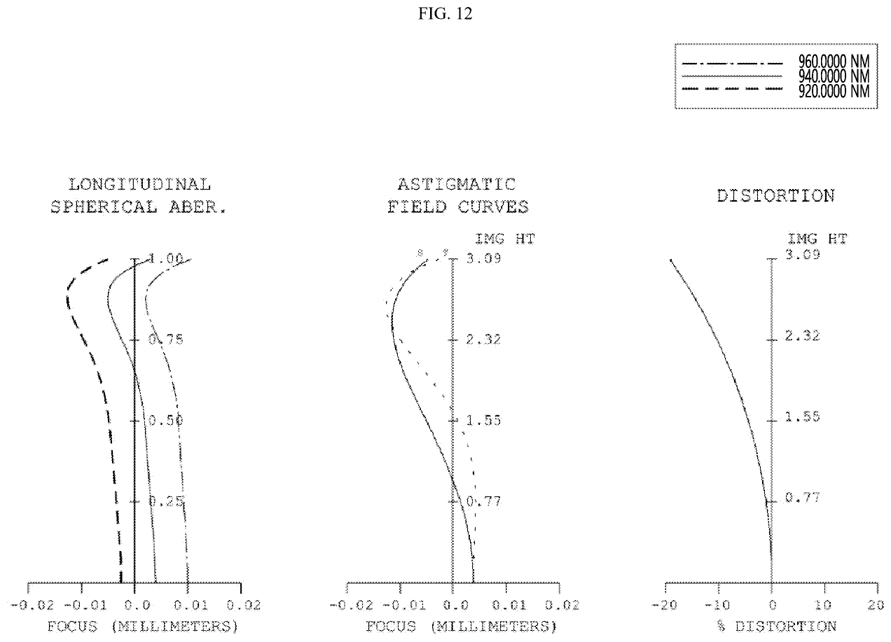

FIGS. 10 to 12 are graphs showing aberration characteristics at room temperature, low temperature, and high temperature in the optical system of FIG. 1. In the aberration graphs of FIGS. 10 to 12, spherical aberration (longitudinal spherical aberration), astigmatic field curves, and distortion are measured from left to right. In FIGS. 10 to 12, the X-axis may represent a focal length (mm) and a degree of distortion (%), and the Y-axis may represent the height of the image. In addition, the graph for spherical aberration is a graph for light in wavelength bands of about 920 nm, about 940 nm, and about 960 nm, and the graphs for astigmatism and distortion are graphs for light in wavelength bands of about 940 nm. In the aberration diagrams of FIGS. 10 to 12, the closer each curve at room temperature, low temperature, and high temperature is to the Y-axis, the better the aberration correction function may be interpreted. It may be seen that the optical system 1000 according to the embodiment has measurement values close to the Y-axis in almost all areas. That is, the optical system 1000 according to the embodiment has improved resolution and may have good optical performance not only in the center of the FOV but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature may be in the range of 85 degrees or higher, for example, in the range of 85 degrees to 105 degrees. Accordingly, it may be seen that the decrease in the luminance ratio (modulation) from the low temperature to the high temperature of FIGS. 10 to 12 is less than 10%, for example, 5% or lower, or is almost unchanged.

Table 1 compares the changes in optical characteristics such as EFL, BFL, F number, TTL, and diagonal FOV at room temperature, low temperature, and high temperature in the optical system according to the first embodiment, and it may be seen that the change rate of optical characteristics at low temperature is 5% or less, for example, 3% or less, based on room temperature, and it may be seen that the change rate of optical characteristics at low temperature is 5% or less, for example, 3% or less, based on room temperature.

TABLE 1

| | | | | Low temperature/ | High temperature/ |
|---|---|---|---|---|---|
| | Room | Low | High | room temperature | room temperature |
| | temperature | temperature | temperature | (%) | (%) |
| EFL | 5.169 | 5.167 | 5.167 | 100.04% | 100.00% |
| BFL | 2.000 | 2.002 | 2.002 | 99.90% | 100.00% |
| F# | 2.200 | 2.2 | 2.200 | 100.00% | 100.00% |
| TTL | 12.499 | 12.502 | 12.504 | 99.98% | 100.02% |
| FOV | 72.85 | 72.85 | 72.86 | 100.00% | 100.00% |

Therefore, as shown in Table 1, it may be seen that the change in optical characteristics according to the temperature change from low temperature to high temperature, for example, the change rate of the effective focal length (EFL), TTL, BFL, F number (F #), and diagonal FOV, is 10% or less, that is, 5% or less, for example, in the range of 0 to 5%. This means that even if at least one or two or more aspherical lenses are used, the temperature compensation for the aspherical lenses may be designed to prevent the reliability of the optical characteristics from deteriorating. In addition, it may be seen that even if the temperature changes from room temperature to low or high temperature, the effective focal length, TTL, BFL, F number (F #), and diagonal FOV hardly change. The optical system of the embodiment disclosed above can effectively control aberration characteristics such as chromatic aberration and distortion aberration, and may have good optical performance not only at the center but also at the periphery of the FOV.

The optical system 1000 according to the embodiment disclosed above may satisfy at least one or two or more of the Equations described below. Accordingly, the optical system 1000 according to the embodiment may have improved optical characteristics. For example, when the optical system 1000 satisfies at least one Equation, the optical system 1000 can effectively control aberration characteristics such as chromatic aberration and distortion aberration, and may have good optical performance not only in the center of the FOV but also in the periphery. In addition, the optical system 1000 may have improved resolution. In addition, the thickness of the lens on the optical axis OA and the distance between adjacent lenses on the optical axis OA described in the Equations can refer to the embodiment disclosed above.

$$0.5 < CT 1 / CT 2 < 1.5 \qquad [ Equation 1 ]$$

CT1 means the center thickness of the first lens 101, and CT2 means the center thickness of the second lens 102. Equation 1 sets the difference in the center thickness of the first and second lenses small, so that the optical path of the optical system may be easily adjusted. Preferably, 0.8<CT1/CT2<1.2 may be satisfied. The center thickness of the first lens 101 having an aspherical surface and the second lens 102 having a spherical surface may be set, so that the optical performance of the center and periphery of the FOV may be improved.

$$( CT 5 * CA 5 ) < ( CT 3 * CA 3 ) \qquad [ Equation 2 ]$$

CT5 is the center thickness of the fifth lens 105, CA5 is the effective diameter of the fifth lens 105, CT3 is the center thickness of the third lens 103, and CA3 is the effective diameter of the third lens. The effective diameter is the average of the effective diameters of the object-side surface and the sensor-side surface of each lens. Preferably, the following condition may satisfy: CA5<CA3. By setting the thickness and effective diameter of the third and fifth lenses, the optical system can improve aberration.

$$Po 1 < 0 \qquad [ Equation 3 ]$$

In Equation 3, Po1 means the power of the first lens 101, and may be set to have an effective focal length F similar to TTL in the optical system for the performance of the optical system. Accordingly, TTL>F may be satisfied, and for example, the following condition may satisfy: 1<TTL/F<4.

$$\vert Po 1 * 2 \vert \leq Po 3 \qquad [ Equation 4 ]$$

Po3 means the power of the third lens 103, and may be set to more than twice the power of the first lens 101 for the performance of the optical system. Accordingly, the center thickness of the third lens 103 may be increased and the curvature radius may be reduced, so that the sensitivity of the light passing through the third lens 103 may be lowered. Preferably, |Po1*2|<Po3 may be satisfied.

$$\vert Po 1 * 2 \vert \leq Po 4 \qquad [ Equation 4 - 1 ]$$

Po4 means the power of the fourth lens 104, and may be set to more than twice the power of the first lens 101 for the performance of the optical system. Accordingly, the center thickness of the fourth lens 104 may be increased and the curvature radius may be reduced, so that the sensitivity of the light passing through the fourth lens 104 may be lowered. Preferably, |Po1*2|<Po4 may be satisfied.

$$1. 7 \leq Nd 3 < 2.2 \qquad [ Equation 5 ]$$

Nd3 is the refractive index of the d-line of the third lens 103. Equation 5 sets the refractive index of the third lens high, so that it can control the factor affecting the reduction of the third aberration (Seidel aberration) of the optical system, and can reduce the aberration that may occur when the TTL is somewhat longer. Equation 5 preferably satisfies: 1.8≤Nd3≤2.1. If it is designed to be lower than the lower limit of Equation 4, the aberration may be reduced to obtain performance, but the power of the third lens 103 is weakened, so that light cannot be collected efficiently, and the performance of the optical system may deteriorate. If it is designed to be higher than the upper limit of Equation 4, there is a disadvantage that it is difficult to obtain materials. In addition, if the refractive index of the third lens is designed to be lower than the lower limit of Equation 4, the curvature radius of the third lens must be increased to increase the power of the third lens, in which case lens manufacturing becomes more difficult, the lens failure rate increases, and the yield may decrease.

$$1.7 \leq Nd 4 < 2.2 \qquad [ Equation 5 - 1 ]$$

Nd4 is the refractive index of the fourth lens 104 at the d-line. Equation 5 may set the refractive index of the fourth lens high. Equation 5-1 may preferably satisfy: 1.8≤Nd4≤2.1.

1.60≤Aver(Nd1:Nd7)≤1.70 [Equation 5-2]

In Equation 5-2, Aver(Nd1: Nd7) is the average of the refractive index values at the d-line of the first to fifth lenses. When the optical system 1000 according to the embodiment satisfies Equation 5-2, the optical system may set the resolution and suppress the influence on TTL.

$$40 < FOV\_H < 60 \qquad [ Equation 6 ]$$

In Equation 6, FOV_H means the horizontal field of view and may set the range of the vehicle optical system. The horizontal field of view may be set in an optical system having 6 or less lenses having at least one aspherical lens and at least two or more spherical lenses. Equation 6 preferably satisfies: 45≤FOV_H≤58, or a range of 55 degrees±3 degrees. When Equation 6 is satisfied, the change rate of the effective focal length and the change rate of the field of view when the temperature changes from room temperature to high temperature may be set to 5% or less, for example, 0 to 5%. Also, even if an aspherical lens and a spherical lens are mixed and used in the optical system 1000, the deterioration of the optical characteristics may be prevented through the temperature compensation of the glass lens.

$$L 1 R 1 > 0 \qquad [ Equation 7 ]$$

L1R1 means the curvature radius of the first surface S1 of the first lens 101 and may be set to be greater than 0. If Equation 7 is satisfied, the shape of the optical system may be limited. The object-side surface of the first lens 101 has a convex shape from the optical axis toward the driver, and can increase the amount of incident light. In addition, since the following condition satisfies: L1R1*L1R2>0, the incident light may be refracted in a direction closer to the optical axis. Accordingly, the embodiment can provide the effective diameter of the second lens to be smaller than the effective diameter of the first lens.

$$L 2 R 1 < 0 , L 3 R 2 < 0 , and L 4 R 2 < 0 \qquad [ Equation 7 - 1 ]$$

L2R1 is the curvature radius of the object-side surface of the second lens 102, L3R2 is the curvature radius of the sensor-side surface of the third lens 103, and L4R2 is the curvature radius of the sensor-side surface of the fourth lens. Since the first lens has a meniscus shape convex toward the object side, and the third and fourth lenses have convex shapes on both sides, the incident light may be refracted from the second lens 102 with the smallest effective diameter to the effective region of the fourth lens with the largest effective diameter. Since the first lens has a meniscus shape convex toward the object side, the effective diameters of the lenses may be designed to gradually increase from the aperture stop position toward the sensor, thereby reducing the number of lenses. In addition, if the following conditions satisfy: L1R1>L1R2 and |L3R1|>L3R2, the effective diameter of the second lens may be designed to be minimal, and the TTL may be reduced. If the following condition of |L3R1|<L3R2, there is a problem that the TTL increases. By setting the curvature radius of the third and fourth lenses to be larger than that of the other lenses, but less than 20 mm, the influence of the optical characteristics on the incident light may be reduced.

$$0.5 < BFL / Max\_Sag52 to Sensor < 1.5 \qquad [ Equation 8 ]$$

BFL is the optical axis distance from the center of the sensor-side surface of the last lens, i.e., the fifth lens, to the surface of the image sensor. Max_Sag52 to Sensor may be the maximum Sag value of the sensor-side surface of the fifth lens 105, i.e., the distance in the optical axis direction from the low point to the image sensor 300. If the optical system satisfies Equation 8, TTL may be reduced and conditions for manufacturing a camera module may be set. In addition, Max_Sag52 to Sensor may set the space where the optical filter 500 and cover glass 400 located between the image sensor 300 and the fifth lens 105 may be placed. If the range of Equation 8 is smaller than the lower limit, the space for placing the circuit structure such as the optical filter or the image sensor becomes restricted, and the process of assembling the structure to the optical system may become difficult. If the range of Equation 8 is larger than the upper limit, the process of assembling circuit structures such as filters and image sensors into the optical system is easy, but the TTL becomes long, making it difficult to miniaturize the optical system. If the sensor-side surface of the last lens does not have a point that protrudes more toward the image sensor than the center of the sensor-side surface between the optical axis and the edge, Max_Sag52 is 0, and the value of Equation 8 may be equal to the BFL (Back focal length).

$$0.5 < CT 1 / CT 5 < 1.5 \qquad [ Equation 9 ]$$

If Equation 9 is satisfied, the aberration characteristics may be improved and the influence on the reduction of the optical system may be set. Equation 9 preferably satisfies 0.85<CT1/CT5<1.25, or CT1 and CT5 may be the same. Equation 9 sets the center thickness of the first lens on the object side of the optical system and the fifth lens having a spherical surface, and can limit the difference in their center thicknesses. Accordingly, the chromatic aberration of the optical system may be improved, and good optical performance may be achieved at the set field of view, and TTL may be controlled.

$$0 < CT 1 / CA 11 < 0.5 \qquad [ Equation 9 - 1 ]$$

In Equation 9-1, the center thickness CT1 of the first lens 101 and the effective diameter CA11 of the object-side surface S1 of the first lens 101 may be set, and if these are satisfied, the strength and optical characteristics of the glass lens may be prevented from being deteriorated. If it is lower than the range of Equation 9-1, the lens may be damaged or injection molding may be difficult, and if it is larger than the above range, the TTL may increase and the weight of the optical system may become heavy. Preferably, 0<CT1/CA11<0.3 may be satisfied.

$$1 < CT 4 / ( CT 1 + CT 2 + CT 5 ) < 2 \qquad [ Equation 10 ]$$

CT1, CT2, CT4, and CT5 mean the center thicknesses of the first, second, third, and fifth lenses. When the optical system satisfies Equation 10, the ratio of the center thickness of the thickest fourth lens to the center thicknesses of the thin lenses may be set, and the aberration characteristics may be improved and the influence on the reduction of the optical system may be set. Equation 10 preferably satisfies: 1<CT4/(CT1+CT2+CT5)<1.5.

$$1 < CT 3 / ( CT 1 + CT 5 ) < 2.5 \qquad [ Equation 11 ]$$

In Equation 11, the center thickness of the third lens 103 may be set to be larger than the sum of the center thicknesses of the first and fifth lenses, so that the third lens, which is convex on both sides, can guide light to the entire region of the fourth lens.

$$4 < CT 34 / CT 5 < 10 \qquad [ Equation 12 ]$$

CT34 is the sum of the center thicknesses of the third and fourth lenses. When Equation 12 is satisfied, by arranging the sum of the center thicknesses of the third and fourth lenses to exceed the center thickness of the fifth lens 105 by four times, the sensitivity of light passing through the third and fourth lenses 103 and 104 may be lowered and the assemblability of the third and fourth lenses 103 and 104 may be improved. Preferably, 6<CT34/CT5<8 may be satisfied.

$$1 < CA 11 / CA 21 < 2 \qquad [ Equation 13 ]$$

CA11 means the effective diameter of the first surface S1 of the first lens 101, and CA21 means the effective diameter of the third surface S3 of the second lens 102. When Equation 13 is satisfied, the optical system 1000 can control the incident light and set the factors affecting the aberration, and preferably, 1<CA11/CA31<1.6 may be satisfied. Since the first and second lenses satisfy Equation 13, the difference in effective diameters between the first and second lenses is not large, so that the influence due to assembly may be reduced and the optical influence due to temperature change may be reduced.

$$1 < CA 52 / CA 21 < 3 \qquad [ Equation 14 ]$$

CA52 means the effective diameter of the tenth surface S10 of the fifth lens 105, and CA21 means the effective diameter of the third surface S3 of the second lens 102. When Equation 14 is satisfied, the optical system 1000 can control the incident light path and set the factors for the performance change according to CRA and temperature. Preferably, Equation 14 may satisfy: 1.8<CA52/CA21<2.5. Equation 14 may set the effective diameter of the object-side surface of the first lens of the second lens group and the sensor-side surface of the last lens.

$$0 < CA 12 / CA 21 < 2 \qquad [ Equation 15 ]$$

CA12 means the effective diameter of the second surface S2 of the first lens 101, and CA21 means the effective diameter of the third surface S3 of the second lens 102. When the optical system 1000 according to the embodiment satisfies Equation 15, the light traveling from the first lens group LG1 to the second lens group LG2 may be controlled, and a factor affecting the decrease in lens sensitivity may be set. Equation 15 can preferably satisfy: 0.8<CA12/CA21<1.5. Since the first and second lenses satisfy Equation 15, the size for assembling the spherical lens and the aspherical lens may be set.

$$0 < \sum ASL\_CT / \sum SSL\_CT < 0.5 \qquad [ Equation 16 ]$$

ΣASL_CT is the sum of the center thicknesses of the aspherical lenses, for example, the center thickness of the first lens. ΣSSL_CT is the sum of the center thicknesses of the spherical lenses, for example, the sum of the center thicknesses of the second to fifth lenses. If Equation 16 is satisfied, the relationship between the thickness of the aspherical lens and the thickness of the spherical lens compared to the TTL may be set to control the overall TTL. Equation 16 in the embodiment preferably satisfies: 0<ΣASL_CT/ΣSSL_CT<0.2.

$$0 < \sum ASL\_CT / TD < 0.2 \qquad [ Equation 17 ]$$

TD is the optical axis distance from the center of the object-side surface of the first lens to the center of the sensor-side surface of the last fifth lens. Equation 17 may set the relationship between the sum of the center thicknesses of the aspherical lenses of the optical system and the maximum optical axis distance between the lenses. Equation 17 can preferably satisfy: 0<ΣASL_CT/TD<0.1.

$$0.2 < \sum SSL\_CT / TD < 0.7 \qquad [ Equation 18 ]$$

Equation 18 may set the relationship between the sum of the center thicknesses of the spherical lenses of the optical system and the maximum optical axis distance between the lenses. Preferably, 0.4≤ΣSSL_CT/TD<0.6 may be satisfied.

$$0 \text{.1} < \sum SSL\_CT / TTL < 0.6 \qquad [ Equation 19 ]$$

Equation 19 may set the relationship between the sum of the center thicknesses of spherical lenses and the total optical length (TTL). Equation 19 can preferably satisfy: 0.3≤ΣSSL_CT/TTL≤0.5.

$$1 < SSL\_CA \_Aver / ASL\_CA \_Aver < 2 \qquad [ Equation 20 ]$$

SSL_CA_Aver means the average effective diameter of glass lenses having a spherical surface, and ASL_CA_Aver means the average effective diameter of glass mold lenses having an aspherical surface. By setting the effective diameters of the spherical lens and the aspherical lens in Equation 20, the path of the incident light may be effectively guided. Equation 20 can preferably satisfy: 1<SSL_CA_Aver/ASL_CA_Aver<1.5. The embodiment can reduce the number of lenses and prevent deterioration of optical characteristics by mixing spherical lenses and aspherical lenses within an optical system.

$$0 < SSL\_Nd \_Aver / ASL\_Nd \_Aver < 1.6 \qquad [ Equation 21 ]$$

SSL_Nd_Aver is the average refractive index of spherical lenses, and ASL_Nd_Aver is the average refractive index of aspherical lenses. Preferably, the refractive index of the spherical lens and the refractive index of the aspherical lens may be set to satisfy the following condition: 1<SSL_Nd_Aver/ASL_Nd_Aver<1.3.

$$\sum ASL\_Nd < \sum SSL\_Nd \qquad [ Equation 21 - 1 ]$$

ΣASL_Nd is the sum of the refractive indices of the aspherical lenses, and ΣSSL_Nd is the sum of the refractive indices of the spherical lenses. The optical system can adjust the resolution and color dispersion by setting the sum of the refractive indices of the spherical lenses to be higher than the sum of the refractive indices of the object-side aspherical lenses.

$$( CG 1 + CG 2 ) < CT 3 \qquad [ Equation 22 ]$$

CG1 is the center distance between the first and second lenses, and CG2 is the center distance between the second and third lenses. In Equation 22, the TTL may be adjusted by increasing the center thickness of the third lens and reducing the center distance between the first and third lenses. Here, the following condition may satisfy: (CT1*2)<CG2 or (CT2*2)<CG2.

$$0. 20 < LD 12 / LD 35 < 0.50 \qquad [ Equation 23 ]$$

LD12 is the optical axis distance between two lenses adjacent to the object, for example, the optical axis distance from the center of the object-side surface of the first lens 101 to the center of the sensor-side surface of the second lens 102. LD35 is the optical axis distance of three lenses adjacent to the sensor, and is the optical axis distance from the center of the object-side surface of the third lens 103 to the center of the sensor-side surface of the fifth lens 105. In Equation 23, the optical axis distances of the lenses 101 and 102 arranged on the object are made small, and the optical axis distances of the lenses 103, 104, and 105 disposed on the sensor side are made large, so that distortion and chromatic aberration caused by the first and second lenses 101 and 102 may be corrected. Preferably, the optical axis distance from the object-side surface of the first lens 101 to the sensor-side surface of the second lens 102 may be set to be 26% or more and 36% or less of the optical axis distance from the object-side surface of the third lens 103 to the sensor-side surface of the fifth lens 105. Since Equation 23 is satisfied, it can reduce aberrations and distortions that may occur in optical systems with small TTL. That is, it may satisfy: 0.26≤LD12/LD35≤0.36.

$$0 < LD 12 / TTL < 0.3 \qquad [ Equation 24 ]$$

In Equation 24, by setting the optical axis distance of the two lenses on the object side relative to the total length (TTL), the effective diameter, curvature radius, refractive index, Abbe number, etc. of the glass lenses may be set. Preferably, it may satisfy: 0.11≤LD12/TTL≤0.23.

$$0 < CT 4 / TTL < 0.3 \qquad [ Equation 25 ]$$

In Equation 25, by setting the center thickness of the fourth lens to the above range based on TTL, light incident through the first to third lenses may be refracted to the entire region of the fifth lens, and chromatic aberration of the optical system may be improved.

$$0.4 < CT 4 / ImgH < 0.9 \qquad [ Equation 25 - 1 ]$$

In Equation 25-1, by setting the center thickness of the third lens to the above range relative to ImgH, change in optical characteristics due to temperature change may be reduced.

$$0 < \vert L 2 R 1 / L 5 R 2 \vert < 1 \qquad [ Equation 26 ]$$

L2R1 is the curvature radius of the third surface of the second lens, and L5R2 is the curvature radius of the tenth surface of the fifth lens. In Equation 26, the curvature radius of the object-side surface of the second lens and the sensor-side surface of the fifth lens may be set to control the power of the second and fifth lenses. Accordingly, good optical performance may be achieved at the center and periphery of the field of view. Preferably, Equation 26 may satisfy: 0<|L2R1/L5R2|<0.5.

$$3 < \vert L 5 R 1 / CT 5 \vert < 10 \qquad [ Equation 27 ]$$

L5R1 means the curvature radius of the object-side surface of the fifth lens. When Equation 27 is satisfied, the power of the fourth lens may be controlled to control the incident light as an aspherical lens, and the deterioration of the aspherical assembly may be prevented. Preferably, 6≤|L5R1/CT5|<9 may be satisfied.

$$1.2 < \vert L 3 R 1 / L 3 R 2 \vert < 5 \qquad [ Equation 28 ]$$

L3R1 is the curvature radius of the object-side surface of the third lens, and L3R2 is the curvature radius of the sensor-side surface of the third lens. If Equation 28 is satisfied, the sensitivity of light may be lowered by adjusting the curvature radius of the lens located at the center of the optical system. Preferably, 2≤|L3R1/L3R2|<2.5 may be satisfied.

$$0.5 < \vert L 4 R 1 / L 4 R 2 \vert < 1.5 \qquad [ Equation 29 ]$$

L4R1 is the curvature radius of the object-side surface of the fourth lens, and L4R2 is the curvature radius of the sensor-side surface of the fourth lens. If Equation 29 is satisfied, the sensitivity of light may be lowered by adjusting the curvature radius of the lens located at the center of the optical system. Preferably, |L4R1/L4R2|=1 may be satisfied.

$$\vert S 7 SagD 1 \vert - \vert S 8 SagD 1 \vert < 0.2 mm \qquad [ Equation 30 ]$$

S7SagD1 is a Sag value at a first distance D1 from the optical axis on the seventh surface S7 of the fourth lens 104, and S8SagD1 is a Sag value at a first distance D1 from the optical axis on the eighth surface S8 of the fourth lens 104. That is, the fourth lens 104 may have a difference of less than 0.2 mm between the Sag values of the seventh surface and the eighth surface S8 at a point spaced apart from the optical axis by the first distance D1. The first distance D1 is a point at half the average effective radius of the fourth lens 104 based on the optical axis. Here, S7SagD1>0 and S8SagD1<0.

$$0.5 < SD / TD < 1 \qquad [ Equation 31 ]$$

SD is the optical axis distance from the aperture stop to the center of the sensor-side surface of the last lens, and TD is the optical axis distance from the center of the object-side surface of the first lens to the center of the sensor-side surface of the last lens. In other words, the relationship between the position of the aperture stop and the maximum distance between the entire lenses may be set. Preferably, 0.8<SD/TD<0.95 may be satisfied.

$$0.5 < CT\_Max / CG\_Max < 1.5 \qquad [ Equation 32 ]$$

In Equation 32, the maximum center thickness CT_Max among the lenses and the maximum center distance CG_Max between adjacent lenses may be set. When Equation 32 is satisfied, the optical system may have good optical performance at the focal length at the set field of view and can reduce the TTL. Preferably, the embodiment may satisfy: 0.8<CT_Max/CG_Max<1.2.

$$1 < \sum CT / \sum CG < 5 \qquad [ Equation 33 ]$$

In Equation 33, ΣCT is the sum of the center thicknesses of the lenses, and ECG is the sum of the center distances between adjacent lenses. If Equation 33 is satisfied, the optical system may have good optical performance at the focal length at the set field of view, and can reduce the TTL. Preferably, the embodiment may satisfy 1<ΣCT/ECG<1.5.

$$6 < \sum Nd < 11 \qquad [ Equation 34 ]$$

ΣNd means the sum of the refractive indices of each of the d-lines of the plurality of lenses. If Equation 34 is satisfied, the optical system 1000 in which the aspherical lens and the spherical lens are mixed can control the TTL, and may have improved resolution. In addition, by arranging glass lenses having relatively high refractive indices and thick thicknesses at the center, the TTL and refractive indices may be set. Equation 34 preferably satisfies: 6≤ΣNd≤10.

$$10 < \sum Abbe / \sum Nd < 50 \qquad [ Equation 35 ]$$

ΣAbbe means the sum of the Abbe numbers of each of the plurality of lenses. When Equation 35 is satisfied, the optical system 1000 may have improved aberration characteristics and resolution. Equation 35 sets the sum of the Abbe numbers and the sum of the refractive indices of the lenses, thereby controlling the optical characteristics, and preferably satisfies: 28<ΣAbbe/ΣNd<40.

$$0.5 < CA 11 / CA\_Min < 2.5 \qquad [ Equation 36 ]$$

CA11 is the effective diameter of the object-side surface of the first lens, and CA_Min means the minimum effective diameter among the object-side surfaces and the sensor-side surfaces of the lenses. If Equation 36 is satisfied, the optical system can provide a slimmer module while maintaining incident light control and optical performance. Equation 36 preferably satisfies: 1<CA11/CA_Min<2.

$$1 < CA\_Max / CA\_Min < 5 \qquad [ Equation 37 ]$$

CA_Max means the maximum effective diameter among the object-side surfaces and the sensor-side surfaces of the lenses. If Equation 37 is satisfied, the optical system may set the size for a slim and compact structure while maintaining optical performance. Equation 37 preferably satisfies: 2<CA_Max/CA_Min<2.5.

$$1 < CA\_Max / CA\_Aver < 3 \qquad [ Equation 38 ]$$

CA_Aver means the average of the effective diameters of the object-side surfaces and the sensor-side surfaces of the lenses. If Equation 38 is satisfied, the optical system may set the size for a slim and compact structure while maintaining optical performance. Equation 38 preferably satisfies: 1<CA_Max/CA_Aver<1.5.

$$20 < CA\_Max * nL < 32 \qquad [ Equation 39 ]$$

nL is the number of lenses of the optical system, and can be, for example, 5. If Equation 39 is satisfied, the optical system may set the maximum effective diameter according to the total number of lenses. Equation 39 preferably satisfies: 25<CA_Max*nL<30.

0.5<CA_Max/(2*ImgH)<2 [Equation 40]

Equation 40 may be set to the maximum effective diameter CA_Max of the lens surfaces and the diagonal length of the image sensor, and if it satisfies this, the optical system can maintain good optical performance and set the size for a slim and compact structure. Preferably, 0.6<CA_Max/(2*ImgH)<1 may be satisfied.

$$0.5 < TD / CA\_Max < 4 \qquad [ Equation 41 ]$$

If Equation 41 is satisfied, the total optical axis distance and the maximum effective diameter of the lenses may be set, and the size for good optical performance may be set. Equation 41 can preferably satisfy: 1.5<TD/CA_Max<2.2.

$$0 < TD / CT\_Max < 0.7 \qquad [ Equation 42 ]$$

In Equation 42, the maximum center thickness and the maximum optical axis distance of the lenses may be set, and good optical performance may be improved. Preferably, 0≤TD/CT_Max≤0.3 may be satisfied.

$$0 < F / CA 51 < 15 \qquad [ Equation 43 ]$$

F means the effective focal length (EFL) of the optical system, and may be less than 15 mm or less than 10 mm, for example, in the range of 1 mm to 10 mm. In Equation 43, the relationship between the effective focal length and the effective diameter of the object-side surface of the last spherical lens may be set, and the influence on optical system reduction, for example, TTL, may be controlled. Equation 43 can preferably satisfy: 0.8<F/CA51<1.2.

$$0 < F / L 1 R 1 < 2 \qquad [ Equation 44 ]$$

In Equation 44, the effective focal length of the optical system and the curvature radius of the object-side surface of the first lens are set, so that the influence on the incident light and TTL may be controlled. Equation 44 preferably satisfies: 1<F/L1R1<1.5.

$$0.5 < Max ( CT / ET ) < 1.5 \qquad [ Equation 45 ]$$

Max(CT/ET) means the maximum value of the ratio of the center thickness and edge thickness of each lens. When Equation 45 is satisfied, the optical system can control the influence on the effective focal length. Equation 45 preferably satisfies: 0.8<Max(CT/ET)<1.2.

To describe the ratio of the center thickness and edge thickness of the spherical lens and the aspherical lens within the lens unit, the following condition may satisfy: Max_SSL(CT/ET)>Max_ASL(CT/ET). Max_SSL(CT/ET) means the maximum ratio of the center thickness and edge thickness among the spherical lenses, and Max_ASL(CT/ET) may mean the maximum ratio of the center thickness and edge thickness of the aspherical lens.

$$0 < EPD / L 1 R 1 < 1 \qquad [ Equation 46 ]$$

EPD means the size (mm) of the entrance pupil diameter of the optical system 1000. When the optical system 1000 according to the embodiment satisfies Equation 46, the optical system 1000 can control the incident light. Equation 46 can preferably satisfy: 0.5<EPD/L1R1<0.8.

$$1 < \vert F 1 / F 3 \vert < 4 \qquad [ Equation 47 ]$$

F1 is the focal length of the first lens, and F3 is the focal length of the third lens. If Equation 47 is satisfied, the power of the first and third lenses may be controlled to improve the resolution, and can affect the TTL and effective focal length (F). Preferably, 2≤F1/F3≤2.7 may be satisfied.

$$\vert F 1 \vert > F 4 \qquad [ Equation 47 - 1 ]$$

$$\vert F 1 \vert > F 3 \qquad [ Equation 47 - 2 ]$$

$$\vert F 1 \vert < \vert F 2 \vert \qquad [ Equation 47 - 3 ]$$

$$F < F 4 < \vert F 1 \vert \qquad [ Equation 47 - 4 ]$$

$$F < F 4 < \vert F 5 \vert \qquad [ Equation 47 - 5 ]$$

In Equations 47-1 to 47-5, F1 is the focal length of the first lens, F2 is the focal length of the second lens, F3 is the focal length of the third lens, F4 is the focal length of the fourth lens, and F5 is the focal length of the fifth lens. The power of each lens may be controlled to guide light from the aspherical lens through the spherical lens. An aperture stop ST is arranged on the sensor-side surface of the first lens 101 and 112. The focal length of the lens positioned closer to the sensor than the aperture stop ST and positioned closest to the aperture stop ST is less than 0. In the embodiment of the present invention, the focal length F2 of the second lens 102 should be designed to be less than 0. In this case, since the second lens 102 has a convex meniscus shape toward the sensor, the curvature radius of the object-side surface of the third lens 103 may be increased. Since the third lens 103 has positive power, the effective diameters of the third and fourth lenses may be increased.

The composite focal length F25 of the second to fifth lenses may have positive power. That is, the composite focal length F25 of the lenses positioned closer to the sensor than the aperture stop ST, that is, the lenses positioned closer to the sensor than the aperture stop, is designed to be greater than 0. In this case, the optical system may be miniaturized by reducing the TTL at a horizontal field of view FOV_H of 45 to 60 degrees.

$$\vert Po 5 \vert < Po 4 < Po 3 \qquad [ Equation 48 ]$$

Po3 is the power value of the third lens, Po4 is the power value of the fourth lens, and Po5 is the power value of the fifth lens. The powers of the third and fourth lenses are positive, and the power of the fifth lens is negative, so the fifth lens can compensate for the aberrations occurring in the third and fourth lenses.

$$15 < Vd 2 - Vd 3 < 60 \qquad [ Equation 49 ]$$

In Equation 49, Vd2 is the Abbe number of the second lens, and Vd3 is the Abbe number of the third lens. If Equation 49 is satisfied, the difference in Abbe numbers between adjacent two lenses may be maintained above a certain value, and chromatic aberration may be improved. Equation 49 preferably satisfies: 20<Vd2−Vd3<40.

$$0 < \vert F 25 / F 12 \vert < 2 \qquad [ Equation 50 ]$$

In Equation 50, a relationship between the composite focal length F12 of the first and second lenses and the composite focal length F35 of the third to fifth lenses is set, so that the power of the first and second lens groups may be controlled to improve the resolution, and the optical system may be provided in a slim and compact size. Equation 50 preferably satisfies: 0<|F25/F12|<1.

$$0 < \vert F 25 / F \vert < 2 \qquad [ Equation 51 ]$$

In Equation 51, the relationship between the overall focal length F and the composite focal length F25 of the second to fifth lenses is set, so that the resolution may be improved by controlling the power of each lens. Equation 51 preferably satisfies: 0.5<|F25/F|<1.

$$0 < \vert F 35 / F 12 \vert < 2 \qquad [ Equation 52 ]$$

In Equation 52, the relationship between the composite focal length F12 of the first and second lenses and the composite focal length F35 of the third to fifth lenses is set, so that the composite focal length of the two lenses with small effective diameters and the composite focal length of the three lenses with large effective diameters are set to the above range, so that the resolution may be improved by controlling the composite power of each lens. Equation 52 preferably satisfies: 0<|F35/F12|<1 and F35>0, F12<0.

$$\vert F\_SSL \_Aver \vert < \vert F\_ASL \_Aver \vert \qquad [ Equation 53 ]$$

In Equation 53, F_SSL_Aver is the average of the focal lengths of the spherical lenses, and F_SSL_Aver is the average of the focal lengths of the aspherical lenses. If Equation 53 is satisfied, chromatic aberration and distortion aberration may be improved by combining the spherical lens and the aspherical lens.

$$0 < nASL / nL < 0.5 \qquad [ Equation 54 ]$$

nASL is the number of aspherical lenses, and nL means the number of total lenses. By arranging the number of aspherical lenses in Equation 54 to be less than 0.5 times the number of total lenses, the thickness of the optical system may be reduced, and more diverse power may be provided through the aspherical lens. In addition, Equation 54-1 may satisfy: 0.5<nSSL/nL<1, where nSSL is the number of glass lenses.

$$0.70 < DL 3 S / TTL < 0.90 \qquad [ Equation 55 ]$$

DL3S is the optical axis distance from the center of the object-side surface of the third lens to the image sensor. The optical system may be designed to guide the light without aberration and distortion by setting the center thickness of the third and fourth lenses thick and increasing the center distances between the third to fifth lenses to set the DL3S to the above range relative to the length of the TTL. Preferably, it may satisfy: 0.75≤DL3S/TTL≤0.85. That is, DL3S may be provided in the range of 75% to 85% of the TTL for the optical axis distance from the center of the object-side surface of the third lens to the image sensor.

$$5 mm < TTL < 20 mm \qquad [ Equation 56 ]$$

TTL (Total track length) means the distance from the center of the first surface S1 of the first lens 101 to the surface of the image sensor 300 on the optical axis OA. In Equation 56, by setting TTL to 15 mm or less, a vehicle optical system may be provided. Preferably, 10 mm≤TTL≤15 mm may be satisfied.

$$2 mm < ImgH \qquad [ Equation 57 ]$$

Equation 57 may set ½ of the diagonal length of the image sensor 300 and can provide an optical system having a vehicle sensor size. Equation 57 may preferably satisfy: 2.8 mm≤ImgH<5 mm.

$$1 mm < BFL < 3 mm \qquad [ Equation 58 ]$$

In Equation 58, the BFL (Back focal length) is set to be greater than 1 mm and less than 3 mm, thereby securing the installation space of the optical filter 500 and the cover glass 400, improving the assemblability of the components through the distance between the image sensor 300 and the last lens, and improving the bonding reliability. Equation 58 preferably satisfies: 1.5 mm≤BFL≤2.8 mm. If the BFL is less than the range of Equation 58, some of the light that proceeds to the image sensor may not be transmitted to the image sensor, which may cause a decrease in resolution. If the BFL exceeds the range of Equation 58, stray light may be introduced, which may deteriorate the aberration characteristics of the optical system.

$$1 < BFL / CG 2 < 3 \qquad [ Equation 59 ]$$

In Equation 59, the center distance CG4 between the BFL (Back focal length) and the fourth and fifth lenses may be set, thereby improving the reliability of the joints of the components according to the installation space of the optical filter 500 and the cover glass 400 and the distance between the glass lenses adjacent to the sensor. In Equation 59, it may satisfy: 1.2≤BFL/CG4≤1.5. The center distance CG4 between the fourth and fifth lenses may be the largest within the lens unit.

$$0 < CT 3 / BFL < 1 \qquad [ Equation 60 ]$$

By setting the BFL (Back focal length) in Equation 60 to be larger than the center thickness of the first lens, the installation space for the optical filter 500 and the cover glass 400 may be secured, and the assembly of the components may be improved through the distance between the image sensor 300 and the last lens, and the bonding reliability may be improved. If the BFL does not satisfy Equation 60, some of the emitted light may not be transmitted to the effective region of the image sensor, thereby lowering the resolution. Preferably, 0.5<CT1/BFL≤0.9 may be satisfied.

$$F < 15 mm \qquad [ Equation 61 ]$$

Equation 61 may set the overall effective focal length F to suit the vehicle optical system. Equation 61 may satisfy the range of 1 mm≤F≤10 mm or 3 mm≤F≤8 mm.

$$45 degrees < FOV < 75 degrees \qquad [ Equation 62 ]$$

In Equation 62, FOV (Field of view) means the field of view (Degree) in the diagonal direction of the optical system 1000, and can provide a vehicle optical system of less than 75 degrees. Preferably, 55 degrees≤FOV≤74 degrees may be satisfied.

$$1 < TTL / CA\_Max < 3 \qquad [ Equation 63 ]$$

CA_Max means the largest effective diameter (mm) among the object-side and sensor-side surfaces of the plurality of lenses. Equation 63 sets the relationship between the total optical axis length of the optical system and the maximum effective diameter, and can provide a slim vehicle optical system. Equation 63 can preferably satisfy: 2<TTL/CA_Max≤2.5.

$$3 < TTL / ImgH < 5 \qquad [ Equation 64 ]$$

Equation 64 may set the total optical axis length (TTL) of the optical system and the diagonal length (ImgH) from the optical axis of the image sensor 300. When the optical system 1000 according to the embodiment satisfies Equation 64, the optical system 1000 may have a large ImgH size compared to the TTL for application to the vehicle image sensor 300, thereby providing improved image quality. Equation 64 may preferably satisfy: 3.5≤TTL/ImgH≤4.5.

$$0.1 < BFL / ImgH < 1.5 \qquad [ Equation 65 ]$$

Equation 65 may set the optical axis distance between the image sensor 300 and the last lens and the diagonal length from the optical axis of the image sensor 300. When the optical system 1000 according to the embodiment satisfies Equation 65, the optical system 1000 can secure a BFL (Back focal length) for applying the size of the vehicle image sensor 300, set the distance between the last lens and the image sensor 300, and have good optical characteristics at the center and periphery of the field of view (FOV). Equation 65 is preferably 0.5<BFL/ImgH<1, and may satisfy the following condition: BFL<ImgH.

$$1 < TTL / BFL < 10 \qquad [ Equation 66 ]$$

Equation 66 may set the total optical axis length (TTL) of the optical system, and the optical axis distance (BFL) between the image sensor 300 and the last lens. When the optical system 1000 according to the embodiment satisfies Equation 66, the optical system 1000 may secure a BFL. Equation 66 may preferably satisfy: 3≤TTL/BFL<5.

$$1 < TTL / F < 3 \qquad [ Equation 67 ]$$

Equation 75 may set the total focal length F and the total optical axis length (TTL) of the optical system 1000. Accordingly, an optical system for a driver assistance system or a driver monitoring system may be provided. Equation 67 may preferably satisfy: 2≤TTL/F<2.8. When the optical system 1000 according to the embodiment satisfies Equation 67, the optical system 1000 may have an appropriate focal length in the set TTL range, and provides an optical system that can maintain an appropriate focal length and form an image even when the temperature changes from low temperature to high temperature. If it is below the lower limit of Equation 67, the power of the lenses needs to be increased, making it difficult to correct spherical aberration or distortion aberration. If it is above the upper limit of Equation 67, the effective diameter or TTL of the lenses becomes longer, which may cause the problem of the imaging lens system becoming larger.

$$1 < F / BFL < 10 \qquad [ Equation 68 ]$$

Equation 68 may set the total effective focal length F of the optical system 1000 and the optical axis distance (BFL) between the image sensor 300 and the last lens. When the optical system 1000 according to the embodiment satisfies Equation 68, the optical system 1000 may have a set field of view and an appropriate focal length, and a vehicle optical system may be provided. In addition, the optical system 1000 can minimize the distance between the last lens and the image sensor 300, so that it may have good optical characteristics in the periphery of the FOV. Equation 68 can preferably satisfy: 1.5<F/BFL<2.5.

$$1 < F / ImgH < 5 \qquad [ Equation 69 ]$$

Equation 69 may set the total effective focal length F of the optical system 1000 and the diagonal length (ImgH) from the optical axis of the image sensor 300. This optical system 1000 may have improved aberration characteristics in the size of the vehicle image sensor 300. Equation 69 may preferably satisfy: 1.2<F/ImgH<2.

$$1 < F / EPD < 5 \qquad [ Equation 70 ]$$

Equation 70 may set the total effective focal length F and the entrance pupil diameter of the optical system 1000. Accordingly, the overall brightness of the optical system may be controlled. Equation 70 can preferably set: 1<F/EPD<3.

$$0 < BFL / TD < 0.5 \qquad [ Equation 71 ]$$

Equation 71 may set the relationship between the optical axis distance TD and the back focal length BFL of the lenses of the optical system 1000. Accordingly, the resolution of the optical system may be maintained and the overall size may be controlled. Equation 71 preferably satisfies: 0.2≤BFL/TD<0.3. If the following condition value of BFL/TD exceeds 0.5, the BFL is designed to be large compared to the TD, so the size of the entire optical system becomes large, making it difficult to miniaturize the optical system, and the distance between the fifth lens and the image sensor becomes long, so that an unnecessary amount of light may increase between the fifth lens and the image sensor, resulting in a problem of lowering the resolution, such as deterioration of aberration characteristics.

$$0 < EPD / ImgH / FOV < 0.2 \qquad [ Equation 72 ]$$

Equation 72 may set the relationship between the size of the entrance pupil diameter (EPD), the length (ImgH) of half the diagonal length of the image sensor, and the diagonal field of view. Accordingly, the overall size and brightness of the optical system may be controlled. Equation 72 can preferably satisfy: 0<EPD/ImgH/FOV<0.1.

$$20 < FOV / F \# < 40 \qquad [ Equation 73 ]$$

Equation 73 may set the relationship between the diagonal field of view and the F number of the optical system. Equation 73 can preferably satisfy: 30<FOV/F #<36. Here, F # is provided as 2.3 or less to provide a bright image.

$$15 < \sum SSL\_CT * nSSL < 22 \qquad [ Equation 74 ]$$

Equation 74 may set the center thickness and number of spherical lenses by the product of the sum ΣSSL_CT of the center thicknesses of the spherical lenses and the number of spherical lenses nSSL. Preferably, Equation 74 may satisfy: 16≤ΣGL_SST*nSSL≤20.

$$0 < \sum ASL\_CT * nASL < 1 \qquad [ Equation 75 ]$$

Equation 75 may set the center thickness and number of aspherical lenses by the product of the sum ΣASL_CT of the center thicknesses of the aspherical lenses and the number of aspherical lenses nASL. Preferably, Equation 75 may satisfy: 0.4<ΣASL_CT*nASL<0.6.

$$40 < TTL * nSSL < 60 \qquad [ Equation 76 ]$$

Equation 76 may set the number of TTL and spherical lenses, and can control color dispersion and refraction angle by spherical lenses in an optical system with TTL of 15 mm or less.

$$8 < ImgH * nSSL < 16 \qquad [ Equation 77 ]$$

Equation 77 may set the number of ImgH and spherical lenses, and can control color dispersion and refraction angle by spherical lenses in an optical system with ImgH of less than 5 mm.

$$\vert Max\_Sag42 \vert < \vert Max\_Sag51 \vert \qquad [ Equation 78 ]$$

Max_Sag42 is the maximum distance in the optical axis direction from a straight line perpendicular to the optical axis on the sensor-side surface of the fourth lens to the sensor-side surface of the fourth lens, and Max_Sag51 is the maximum distance in the optical axis direction from a straight line perpendicular to the optical axis on the object-side surface of the fifth lens to the object-side surface of the fifth lens. When Equation 78 is satisfied, the curvature radius of the lens surfaces of the spherical lenses may be adjusted to guide light to the entire region of the image sensor, and the effective diameters of the fourth and fifth lenses may be adjusted.

$$\vert Max\_Sag52 \vert < \vert Max\_Sag51 \vert \qquad [ Equation 79 ]$$

Max_Sag52 is the maximum distance in the optical axis direction from a straight line perpendicular to the optical axis on the sensor-side surface of the fifth lens to the sensor-side surface of the fifth lens. When Equation 79 is satisfied, the effective diameter of the fifth lens may be controlled by adjusting the curvature radius of the object-side surface and the sensor-side surface of the fifth lens. Here, Max_Sag52, Max_Sag51<0.

$$[ Equation 80 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + ⋯$$

In Equation 80, Z may mean Sag, which may refer to a distance in the direction of the optical axis from an arbitrary position on the aspherical surface to the vertex of the aspherical surface. The Y may refer to a distance in a direction perpendicular to the optical axis from an arbitrary position on the aspherical surface to the optical axis. The c may refer to the curvature of the lens, and K may refer to the conic constant. In addition, A, B, C, D, E, and F may refer to aspheric coefficients.

The optical system 1000 according to the embodiment may satisfy at least one or two or more of Equations 1 to 40. At least one or more of Equations 1 to 40 may satisfy at least one or more of Equations 41 to 79. In this case, the optical system 1000 may have improved optical characteristics. In detail, when the optical system 1000 satisfies at least one of Equations 1 to 40 and/or at least one of Equations 41 to 79, the optical system 1000 may have improved resolution and may improve aberration and distortion characteristics. In addition, the optical system 1000 may secure a BFL for applying a vehicle image sensor 300, compensate for optical characteristic degradation due to temperature change, and minimize the distance between the last lens and the image sensor 300, thereby having good optical performance at the center and periphery of the FOV.

Table 2 shows the items of the Equations described above in the optical system 1000 of the embodiment, including the TTL (mm), BFL, effective focal length F (mm), ImgH (mm), effective diameter CA (mm), TD (mm), which is the optical axis distance from the first surface S1 to the tenth surface S10, the focal lengths F1, F2, F3, F4, and F5 (mm) of each of the first to fifth lenses, the sum of the refractive indices, the sum of the Abbe numbers, the sum of the center thicknesses (mm) of each lens, the sum of the distances between adjacent lenses, the diagonal FOV (Degree), the edge thickness ET, the focal lengths of the first and second lens groups, the composite focal lengths of the second to fourth lenses, the F number, etc. of the optical system 1000.

TABLE 2

| Items | Embodiment | Items | Embodiment |
|---|---|---|---|
| F | 5.167 | ET1 | 1.792 |
| F1 | −12.155 | ET2 | 1.218 |
| F2 | −14.025 | ET3 | 1.850 |
| F3 | 5.075 | ET4 | 2.690 |
| F4 | 7.756 | ET5 | 1.085 |
| F5 | 5.167 | F# | 2.20 |
| F_LG1 | −12.155 | FOV (Diagonal) | 72.866 |
| F_LG2 | 4.269 | EPD | 2.359 |
| F12 | −6.458 | BFL | 2.650 |
| F34 | 3.689 | TD | 9.850 |
| F35 | 3.660 | ImgH | 3.092 |
| ΣNd | 8.200 | SD | 8.479 |
| ΣAbbe | 274.34 | TTL | 12.500 |
| ΣCT | 5.212 | ΣET | 8.6345 |
| ΣCG | 4.638 | | |

Table 3 shows the result values for Equation 1 to Equation 40 described above in the optical system 1000 of the embodiment. Referring to Table 2, it may be seen that the optical system 1000 satisfies at least one, two or more, or three or more of Equation 1 to Equation 40. In detail, it may be seen that the optical system 1000 according to the embodiment satisfies all of Equation 1 to Equation 40. Accordingly, the optical system 1000 may have good optical performance at the center and periphery of the field of view (FOV) and may have excellent optical characteristics.

TABLE 3

| | |
|---|---|
| Equations | Embodiment |

| | | |
|---|---|---|
| 41 | 0.5 < TD/CA_Max < 4 | 1.818 |
| 42 | 0 < CT_Max/TD < 0.7 | 0.190 |
| 43 | 0 < F/CA51 < 1.5 | 1.031 |
| 44 | 0 < F/L1R1 < 2 | 1.363 |
| 45 | 0.5 < Max (CT/ET) < 1.5 | 0.994 |
| 46 | 0 < EPD/L1R1 < 1 | 0.622 |
| 47 | 1 < \|F1/F3\| < 4 | 2.395 |
| 48 | \|Po5\| < Po4 < Po3 | Satisfaction |
| 49 | 15 < Vd2-Vd3 < 60 | 28.948 |
| 50 | 0 < \|F25/F1\| < 2 | 0.661 |
| 51 | 0 < \| F25/F \| < 2 | 0.826 |
| 52 | 0 < \|F35/F12\| < 2 | 0.567 |
| 53 | \|F_SSL_Aver\| < \|F_ASL_Aver\| | Satisfaction |
| 54 | 0 < nASL/nL < 0.5 | 0.200 |
| 55 | 0.70 < DL3S/TTL < 0.90 | 0.80 |
| 56 | 5 < TTL < 20 | 12.500 |
| 57 | 2 < ImgH | 3.092 |
| 58 | 1 < BFL < 3 | 2.650 |
| 59 | 1 < BFL/CG4 < 3 | 1.421 |
| 60 | 0 < CT3/BFL < 1 | 0.707 |
| 61 | F < 15 | 5.167 |
| 62 | 45 < FOV < 75 | 72.866 |
| 63 | 1 < TTL/CA_Max < 3 | 2.307 |
| 64 | 3 < TTL/ImgH < 5 | 4.042 |
| 65 | 0.1 < BFL/ImgH < 1.5 | 0.857 |
| 66 | 1 < TTL/BFL < 10 | 4.717 |
| 67 | 1 < TTL/F < 3 | 2.419 |
| 68 | 1 < F/BFL < 10 | 1.950 |
| 69 | 1 < F/ImgH < 5 | 1.671 |
| 70 | 1 < F/EPD < 5 | 2.191 |
| 71 | 0 < BFL/TD < 0.5 | 0.269 |
| 72 | 0 < EPD/Imgh/FOV < 0.2 | 0.018 |
| 73 | 20 < FOV/F# < 40 | 33.121 |
| 74 | 15 < ΣSSL_CT*nSSL < 22 | 18.848 |
| 75 | 0 < ΣASL_CT*nASL < 1 | 0.500 |
| 76 | 40 < TTL*nSSL < 60 | 50.000 |
| 77 | 8 < ImgH*nSSL < 16 | 12.369 |
| 78 | \|Max_Sag42 \| < \|Max_Sag51\| | Satisfaction |
| 79 | \|Max_Sag52\| < \|Max_Sag51\| | Satisfaction |

Table 4 shows the result values for Equation 41 to Equation 79 described above in the optical system 1000 of the embodiment. Referring to Table 3, it may be seen that the optical system 1000 satisfies at least one, two or more, or three or more of Equation 41 to Equation 79. In detail, it may be seen that the optical system 1000 according to the embodiment satisfies all of Equation 41 to Equation 79. Accordingly, the optical system 1000 may have good optical performance at the center and periphery of FOV and may have excellent optical characteristics.

TABLE 4

| Equations | | Embodiment |
|---|---|---|
| 41 | 0.5 < TD/CA_Max < 4 | 1.818 |
| 42 | 0 < CT_Max/TD < 0.7 | 0.190 |
| 43 | 0 < F/CA51 < 1.5 | 1.031 |
| 44 | 0 < F/L1R1 < 2 | 1.363 |
| 45 | 0.5 < Max (CT/ET) < 1.5 | 0.994 |
| 46 | 0 < EPD/L1R1 < 1 | 0.622 |
| 47 | 1 < \|F1/F3\| < 4 | 2.395 |
| 48 | \|Po5\| < Po4 < Po3 | Satisfaction |
| 49 | 15 < Vd2-Vd3 < 60 | 28.948 |
| 50 | 0 < \|F25/F1\| < 2 | 0.661 |
| 51 | 0 < \| F25/F \| < 2 | 0.826 |
| 52 | 0 < \|F35/F12\| < 2 | 0.567 |
| 53 | \|F_SSL_Aver\| < \|F_ASL_Aver\| | Satisfaction |
| 54 | 0 < nASL/nL < 0.5 | 0.200 |
| 55 | 0.70 < DL3S/TTL < 0.90 | 0.80 |
| 56 | 5 < TTL < 20 | 12.500 |
| 57 | 2 < ImgH | 3.092 |
| 58 | 1 < BFL < 3 | 2.650 |
| 59 | 1 < BFL/CG4 < 3 | 1.421 |
| 60 | 0 < CT3/BFL < 1 | 0.707 |
| 61 | F < 15 | 5.167 |
| 62 | 45 < FOV < 75 | 72.866 |
| 63 | 1 < TTL/CA_Max < 3 | 2.307 |
| 64 | 3 < TTL/ImgH < 5 | 4.042 |
| 65 | 0.1 < BFL/ImgH < 1.5 | 0.857 |
| 66 | 1 < TTL/BFL < 10 | 4.717 |
| 67 | 1 < TTL/F < 3 | 2.419 |
| 68 | 1 < F/BFL < 10 | 1.950 |
| 69 | 1 < F/ImgH < 5 | 1.671 |
| 70 | 1 < F/EPD < 5 | 2.191 |
| 71 | 0 < BFL/TD < 0.5 | 0.269 |
| 72 | 0 < EPD/Imgh/FOV < 0.2 | 0.018 |
| 73 | 20 < FOV/F# < 40 | 33.121 |
| 74 | 15 < ΣSSL_CT*nSSL < 22 | 18.848 |
| 75 | 0 < ΣASL_CT*nASL < 1 | 0.500 |
| 76 | 40 < TTL*nSSL < 60 | 50.000 |
| 77 | 8 < ImgH*nSSL < 16 | 12.369 |
| 78 | \|Max_Sag42 \| < \|Max_Sag51\| | Satisfaction |
| 79 | \|Max_Sag52\| < \|Max_Sag51\| | Satisfaction |

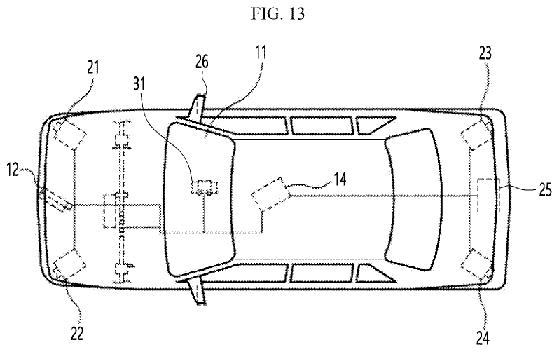

FIG. 13 is an example of a plan view of a vehicle to which a camera module or optical system according to an embodiment of the invention is applied. Referring to FIG. 13, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture images of the front of the vehicle and/or the driver to generate images of the front or interior of the vehicle. The image generating unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generating unit 11 provides the driver image, the front image, and the surrounding image to the control unit 14. Next, the first information generating unit 12 may include at least one radar and/or camera placed in the own vehicle, and detects the front of the own vehicle to generate the first detection information. Specifically, the first information generating unit 12 is placed in the own vehicle and detects the position and speed of vehicles located in front of the own vehicle, whether there is a pedestrian, and the position, etc. to generate the first detection information.

Using the first detection information generated by the first information generating unit 12, the distance between the own vehicle and the vehicle in front may be controlled to be maintained at a constant level, and the stability of vehicle operation may be increased in specific cases set in advance, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle based on the front image generated by the image generating unit 11 and the first detection information generated by the first information generating unit 12 to generate the second detection information. Specifically, the second information generating unit 21, 22, 23, 24, 25, and 26 may include at least one radar and/or camera disposed on the own vehicle, and may detect the position and speed of vehicles located on the side of the own vehicle or capture images. Here, the second information generating unit 21, 22, 23, 24, 25, and 26 may be disposed on each of the front corners, side mirrors, and the rear center and rear corners of the own vehicle.

At least one information generating unit of these vehicle camera systems may be equipped with an optical system and a camera module having the same as described in the above-described embodiments, and may provide or process information acquired through the front, rear, each side, or corner region of the vehicle to a user to enable autonomous driving or to protect the vehicle and objects from surrounding safety. The optical system of the camera module according to the embodiment of the invention may be installed in multiple units in a vehicle to enhance safety regulations, autonomous driving functions, and increase convenience by using an Advanced driving assistance system (ADAS). In addition, the optical system of the camera module is applied in a vehicle as a component for control such as a lane keeping assistance system (LKAS), a lane departure warning system (LDWS), and a driver monitoring system (DMS). This vehicle camera module can implement stable optical performance even under ambient temperature changes and can provide a module with price competitiveness, thereby ensuring the reliability of vehicle components.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
first to fifth lenses sequentially disposed from an object side,
wherein a composite power of the first lens and the second lens is negative,
wherein a composite power of the third to fifth lenses is positive,
wherein an effective diameter of the second lens among effective diameters of the first to fifth lenses is a smallest,
wherein the effective diameter of the first lens is larger than an effective diameter of the second lens and smaller than the effective diameters of the third to fifth lenses,
wherein a power of the third lens among powers of the first to fifth lenses is a largest, and
wherein the power of the fourth lens among the powers of the first to fifth lenses is the second largest.

2. An optical system comprising:
first to fifth lenses sequentially disposed from an object side,
wherein each of the first to fifth lenses has an object-side surface and a sensor-side surface,
wherein a composite power of the first lens and the second lens is negative,
wherein a composite power of the third to fifth lenses is positive,
wherein an effective diameter of the second lens among effective diameters the first to fifth lenses is a smallest,
wherein a power of the third lens among powers of the first to fifth lenses is a largest, and
wherein an optical axis distance from the object-side surface of the first lens to the sensor-side surface of the second lens is in a range of 26% to 36% of an optical axis distance from the object-side surface of the third lens to the sensor-side surface of the fifth lens.

3. An optical system comprising:
first to fifth lenses sequentially disposed from an object side; and
an aperture stop disposed on a periphery between the first lens and the second lens,
wherein an effective diameter of the second lens among effective diameters of the first to fifth lenses is a smallest,
wherein a power of the third lens is positive and has a largest among powers of the first to fifth lenses, and
wherein the power of the fourth lens is positive and greater than the powers of the first, second, and fifth lenses.

4. The optical system of claim 1, comprising:
an image sensor,
wherein curvature radii of an object-side surface and a sensor-side surface of the fourth lens are the same,
wherein a center thickness of the fourth lens among center thicknesses of the first to fifth lenses is a thickest.

5. The optical system of claim 1,
wherein a center distance between the third lens and the fourth lens is greater than a center distance between the first lens and the second lens and a center distance between the second lens and the third lens.

6. The optical system of claim 1,
wherein a center distance between the fourth lens and the fifth lens is a largest among center distances between the first to fifth lenses,
wherein the first to fifth lenses are disposed to be spaced apart from each other along an optical axis.

7. The optical system of claim 3,
wherein the power of each of two lenses arranged in series and having positive power on a sensor side of the aperture stop is at least twice as large as an absolute value of the power of an other lens.

8. The optical system of claim 1, comprising:
an image sensor,
wherein an optical axis distance from an object-side surface of the third lens to the image sensor disposed on a sensor side of the fifth lens is in a range of 75% to 85% of an optical axis distance from an object-side surface of the first lens to the image sensor.

9. The optical system of claim 1,
wherein the first lens has a meniscus shape convex toward the object side on an optical axis,
wherein the second lens has a meniscus shape convex toward a sensor side on the optical axis.

10. The optical system of claim 9,
wherein the third lens has a biconvex shape on the optical axis,
wherein the fourth lens has a biconvex shape on the optical axis.

11. The optical system of claim 10,
wherein the fifth lens has a meniscus shape convex toward the sensor side on the optical axis.

12. The optical system of claim 11,
wherein the first lens has an aspherical object-side surface and an aspherical sensor-side surface,
wherein the second to fifth lenses have a spherical object-side surface and a spherical sensor-side surface.

13. The optical system of claim 1,
wherein the effective diameters of the third to fifth lenses are smaller than a diagonal length of an image sensor.

14. The optical system of claim 2,
wherein refractive indices of the third and fourth lenses are higher than the average of refractive indices of the first to fifth lenses.

15. The optical system of claim 2,
wherein the first to fifth lenses are made of glass, and the object-side surfaces and the sensor-side surfaces of the first to fifth lenses are provided without a critical point.

16. The optical system of claim 1,
wherein S7SagD1 is Sag data at a point spaced a first distance from a center of an object-side surface of the fourth lens,
wherein S8SagD1 is Sag data at a point spaced a first distance from a center of a sensor-side surface of the fourth lens,
wherein the following Equation satisfies: |S7SagD1|−|S8SagD1|<0.2 mm.

17. The optical system of claim 16,
wherein the first distance is a point that is ½ of an average effective radius of the object-side surface and the sensor-side surface of the fourth lens,
wherein the following Equation satisfies: S7SagD1>0 and S8SagD1<0.

18. The optical system of claim 1,
wherein a maximum distance in a direction of an optical axis from a straight line perpendicular to the optical axis on an object-side surface of the fifth lens to the object-side surface of the fifth lens is Max_Sag51,
wherein a maximum distance in a direction of the optical axis from a straight line perpendicular to the optical axis on a sensor-side surface of the fifth lens to the sensor-side surface of the fifth lens is Max_Sag52, and
wherein the following Equation satisfies: |Max_Sag52|<|Max_Sag51|.

19. The optical system of claim 18,
wherein the following Equation satisfies: Max_Sag51<0 and Max_Sag52<0.

20. A camera module comprising:
an optical system according to claim 1,
wherein an optical axis distance from an object-side surface of the first lens of the optical system to an image sensor is TTL,
wherein a total number of the lenses is nL,
wherein a number of aspherical lenses among the first to fifth lenses of the optical system is nASL,
wherein ½ of a diagonal length of the image sensor is ImgH,
wherein the following Equation satisfies: 3<TTL/ImgH<5
wherein the following Equation satisfies: 0<nASL/nL<0.5.
